(19) United States
(12) Patent Application Publication
(10) Pub. No.: US 2022/0252424 A1
(43) Pub. Date: Aug. 11, 2022

(54) SYSTEM AND COMPUTER-IMPLEMENTED METHOD FOR VALIDATING A ROAD OBJECT

(71) Applicant: HERE Global B.V., Eindhoven (NL)

(72) Inventor: Zhenhua ZHANG, Chicago, IL (US)

(21) Appl. No.: 17/168,984

(22) Filed: Feb. 5, 2021

(51) Int. Cl. G01C 21/00; G06K 9/00

(52) U.S. Cl. CPC G01C 21/3896; G06K 9/00805; G01C 21/3804; G01C 21/3874

(57) ABSTRACT

A computer-implemented method is disclosed for validating a road object. The computer-implemented method may include: receiving a road object observation comprising road object location data of the road object; and identifying driving direction data associated with the received road object observation. The computer-implemented method may further include obtaining at least one geographic administrative boundary that is in vicinity of the road object; and determining a distance between the road object and the at least one geographic administrative boundary. Furthermore, the computer-implemented method may include determining a relative position of the road object from the at least one geographic administrative boundary; and validating the road object based on at least two of the driving direction data, the distance between the road object and the at least one geographic administrative boundary and the relative position of the road object from the at least one geographic administrative boundary.

### TECHNOLOGICAL FIELD

The present disclosure generally relates to routing and navigation systems, and more particularly relates to methods and systems for validating a road object in routing and navigation systems.

### BACKGROUND

Currently, various navigation applications are available for vehicle navigation. These navigation applications generally request navigation related data or map data thereof from a navigation service for the vehicle navigation. The map data may include data about navigation routes and road objects on these routes such as road signs, traffic objects, road obstacles and the like. However, the map data provided by the navigation service may not be accurate for the vehicle navigation near administrative boundaries of administrative divisions of a geographic region.

In some situations, administrative boundaries may change due to factors such as political, socio-economic or physical constraints. There may also be a situation where even though administrative boundary has changed, but data about road objects affected by such a change remains outdated in the navigation service. These and other such problems need to be addressed for more accurate navigation application.

### BRIEF SUMMARY OF SOME EXAMPLE EMBODIMENTS

Generally, map data near boundaries of administrative divisions may not be accurate, because the boundaries of the administrative divisions may change when the administrative divisions expand. For instance, road objects posted near the boundaries may be removed or relocated due to expansion of the administrative divisions, new civil constructions, and the like. Hereinafter, ‘boundary’ and ‘administrative boundary’ may be interchangeably used to mean the same. As used herein, the administrative boundary may be a virtual arbitrary shaped boundary that separates one administrative division of a geographic region from other administrative divisions of the country. The administrative division may include at least one of a built-up area (BUA), a non-built-up area (Non-Bua), an in-town area, an out-of-town area, an in-city area, an out-of-city area, a census designated area (CDA) and the like. Since the road objects posted near the administrative boundaries are removed or relocated when the administrative boundaries change, location data associated with the road objects and road object data associated with the road objects may not to be up-to-date for vehicle navigation.

To that end, some embodiments are provided to accurately detect the road objects near the administrative boundaries and update the location data associated with the road objects. According to some example embodiments, the road object near the administrative boundary may be detected by validating the road object based on a distance between the location data associated with the road object and the administrative boundary.

Some embodiments are based on realization that the change in the administrative boundary (e.g. the relocation of the road object near the administrative boundary) may form a short region, for instance, a short road segment between the location of the road object and the administrative boundary. In some other cases, the short region (e.g. the short road segment) may be formed due to GPS fluctuations, sight distance effects and the like. Due to the short road segment, a vehicle traveling from one administrative division to another administrative division may have multiple transitions. For instance, a state of the vehicle may be changed multiple times. As a result of the multiple transitions, the vehicle may end-up with unwanted conditions such as road accidents, increase in travel time, vehicle efficiency reduction, traffic congestions, environmental pollutions, and the like.

To that end, some embodiments are provided to accurately provide one or more navigation functions for the vehicle such that the multiple transitions are reduced while the vehicle is traveling from one administrative division to another administrative division. Accordingly, the unwanted conditions are avoided. According to some embodiments, the one or more navigation functions are provided by validating the road object based on a relative position of the road object and a driving direction data. In some embodiments, the relative position of the road object is determined as at least one of an upstream position with respect to the administrative boundary and a downstream position with respect to the administrative boundary. As used herein, the driving direction data may indicate a direction in which a vehicle is transitioning.

A computer-implemented method, a system and a computer programmable product are provided in accordance with an example embodiment described herein for validating the road object based on the driving direction data, the distance between the road object and the administrative boundary and the relative position of the road object from the administrative boundary.

In one aspect, a computer-implemented method for validating the road object is disclosed. The computer-implemented method may include receiving a road object observation associated with the road object, wherein the road object observation comprises at least road object location data; identifying driving direction data associated with the received road object observation; obtaining administrative boundary data for a geographic region from a map database, wherein the administrative boundary data corresponds to at least one geographic administrative boundary in vicinity of the road object; determining a distance between the road object and the at least one geographic administrative boundary; determining a relative position of the road object from the at least one geographic administrative boundary; and validating the road object based on at least two of the driving direction data, the distance between the road object and the at least one geographic administrative boundary and the relative position of the road object from the at least one geographic administrative boundary.

In additional computer-implemented method embodiments, validating the road object further comprises: identifying a threshold distance associated with the road object and the at least one geographic administrative boundary; comparing the distance between the road object and the at least one geographic administrative boundary with the threshold distance; and validating the road object based on the comparison.

In additional computer-implemented method embodiments, the road object is identified as either one of a valid road object and an invalid road object based on the validation.

In additional computer-implemented method embodiments, the road object is identified as the valid road object when the distance between the road object and the at least one geographic administrative boundary is less than the threshold distance; and the road object is identified as the invalid road object when the distance between the road object and the at least one geographic administrative boundary is more than the threshold distance.

In additional computer-implemented method embodiments, the computer-implemented method further comprises: identifying, a road object value and a road object type, associated with the received road object observation; determining a first attribute value associated with the received road object observation; determining, a second attribute value and a third attribute value, for the received road object observation based on the valid road object, the road object value, the road object type, the first attribute value, and the road object location data, wherein the second attribute value is associated with a first geographic region that is traversed before reaching the road object location and the third attribute value is associated with a second geographic region that is traversed after passing the road object location, wherein the road object location is determined based on the road object location data and is associated with a map of the geographic region obtained from the map database.

In additional computer-implemented method embodiments, the second attribute value is same as the first attribute value and the third attribute value is same as the road object value when: the road object is the valid road object, and the road object type is a speed limit sign.

In additional computer-implemented method embodiments, the second attribute value is same as the first attribute value and the third attribute value is a predefined default value when: the road object is the valid road object, and the road object type is an end of restriction sign.

In additional computer-implemented method embodiments, determining the relative position of the road object further comprises determining the relative position as at least one of: an upstream position with respect to the at least one geographic administrative boundary; and a downstream position with respect to the at least one geographic administrative boundary.

In additional computer-implemented method embodiments, the at least one geographic administrative boundary is associated with at least one of: a built-up-area, a non-built-up-area, a city limit start, a city limit end, an in-town region, an out-of-town region, and a census designated place (CDP).

In additional computer-implemented method embodiments, the driving direction data associated with the received road object observation comprises an indication of transitioning from a first administrative division to a second administrative division based on the obtained administrative boundary data for the geographic region.

In additional computer-implemented method embodiments, the computer-implemented method further comprises: determining a change in the at least one geographic administrative boundary based on the validation of the road object; and updating, based on the determined change, the map database to include updated administrative boundary data for the geographic region.

In another aspect, a system for validating a road object is provided. The system comprises a memory configured to store computer-executable instructions; and at least one processor configured to execute the computer-executable instructions to: receive a road object observation associated with the road object, wherein the road object observation comprises at least road object location data; obtain administrative boundary data for a geographic region from a map database, wherein the administrative boundary data corresponds to at least one geographic administrative boundary in vicinity of the road object; determine a relative position of the road object from the at least one geographic administrative boundary; validate the road object based on the relative position of the road object from the at least one geographic administrative boundary, wherein the road object is identified as either one of a valid road object and an invalid road object based on the validation.

In additional system embodiments, the at least one processor is further configured to generate navigation instructions based on the validation and wherein to generate the navigation instructions, the at least one processor is further configured to: identify, a road object value and a road object type, associated with the received road object observation; determine a first attribute value associated with the received road object observation; determine, a second attribute value and a third attribute value, for the received road object observation based on the validation of the road object, the road object value, the road object type, the first attribute value, and the road object location data, wherein the second attribute value is associated with a first geographic region that is traversed before reaching the road object location and the third attribute value is associated with a second geographic region that is traversed after passing the road object location, wherein the road object location is determined based on the road object location data and is associated with a map of the geographic region obtained from the map database; and generate the navigation instruction to apply the determined second attribute value and the determined third value for navigation of a vehicle associated with the road object observation.

In additional system embodiments, the second attribute value is same as the first attribute value and the third attribute value is same as the road object value when: the road object is the valid road object, and the road object type is a speed limit sign.

In additional system embodiments, the second attribute value is same as the first attribute value and the third attribute value is a predefined default value when: the road object is the valid road object, and the road object type is an end of restriction sign.

In additional system embodiments, to determine the relative position of the road object, the at least one processor is further configured to: determine the relative position as at least one of: an upstream position with respect to the at least one geographic administrative boundary; and a downstream position with respect to the at least one geographic administrative boundary.

In additional system embodiments, the at least one processor is further configured to update the map database based on at least one of the road object location data, the relative position of the road object from the at least one geographic administrative boundary, the road object value, and the road object type.

In yet another aspect, a computer program product comprising a non-transitory computer readable medium having stored thereon computer executable instruction which when executed by at least one processor, cause the processor to carry out operations for providing one or more navigation functions, the operations comprising: receiving location data associated with a road object and a driving direction data; determining an administrative boundary associated with the road object based on a map database; validating the road object based on a distance between the location data associated with the road object and the administrative boundary associated with the road object; determining a change in the administrative boundary, based on the validated road sign and the driving direction data; and providing the one or more navigation functions, based on the determined change in the administrative boundary and the driving direction data, wherein for providing the one or more navigation functions, the operations further comprise at least one of generating navigation instructions and updating the map database.

In additional computer program product embodiments, for determining the change in the administrative boundary, the operations further comprise determining a relative position of the validated road sign with respect to the administrative boundary based on the location data associated with the validated road sign and the driving direction data; identifying whether the validated road sign is located in at least one of a first administrative division and a second administrative division, based on the relative position of the validated road sign, wherein the first administrative division and the second administrative division are separated by the administrative boundary; determining the location data associated with the validated road sign in the first administrative division as a new administrative boundary to indicate the change in the administrative boundary, in response to identifying the validated road sign is located in the first administrative division; and determining the location data associated with the validated road sign in the second administrative division as the new administrative boundary to indicate the change in the administrative boundary, in response to identifying the validated road sign is located in the second administrative division.

In additional computer program product embodiments, the navigation instructions are generated for a vehicle, and wherein for generating the navigation instructions for the vehicle, the operations further comprise: determining a road object value data associated with the validated road sign; determining, based on the driving direction data, whether the vehicle is traveling from the first administrative division to the second administrative division or from the second administrative division to the first administrative division, wherein each of the first administrative division and the second administrative division is at least one of a non-built-up area, an out-of-city area, an out-of-town area, a built-up area, an in-city area, and an in-town area; generating the navigation instructions to change a speed value associated with the vehicle to the road object value associated with the validated road sign after reaching the new administrative boundary, if the validated road sign is the speed limit sign; generating the navigation instructions to change the speed value associated with the vehicle to a default speed limit data associated the second administrative division after reaching the new administrative boundary, in response to determining the vehicle is traveling from the first administrative division to the second administrative division and if the validated road sign is a speed limit end sign; and generating the navigation instructions to change the speed value associated with the vehicle to a default speed limit data associated the first administrative division after reaching the new administrative boundary, in response to determining the vehicle is traveling from the second administrative division to the first administrative division and if the validated road sign is the speed limit end sign.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Having thus described example embodiments of the invention in general terms, reference will now be made to the accompanying drawings, which are not necessarily drawn to scale, and wherein:

FIG. 1 illustrates a block diagram showing an example architecture of a system for validating a road object, in accordance with one or more example embodiments;

FIG. 2 illustrates a block diagram of the system for validating the road object, in accordance with one or more example embodiments;

FIG. 3A illustrates an exemplary working environment of the system for validating the road object, in accordance with one or more example embodiments;

FIG. 3B illustrates a first working environment of the system for validating the road object, in accordance with one or more example embodiments;

FIG. 3C illustrates a second working environment of the system for validating the road object, in accordance with one or more example embodiments;

FIG. 3D illustrates a third working environment of the system for validating the road object, in accordance with one or more example embodiments;

FIG. 3E illustrates a fourth working environment of the system for validating the road object, in accordance with one or more example embodiments;

FIG. 3F illustrates a fifth working environment of the system for validating the road object, in accordance with one or more example embodiments;

FIG. 3G illustrates a sixth working environment of the system for validating the road object, in accordance with one or more example embodiments;

FIG. 3H illustrates a seventh working environment of the system for validating the road object, in accordance with one or more example embodiments;

FIG. 3I illustrates an eighth working environment of the system for validating the road object, in accordance with one or more example embodiments;

FIG. 4A illustrates a flowchart depicting a method for validating the road object, in accordance with one or more example embodiments; and

FIG. 4B illustrates a flowchart depicting another method for validating the road object, in accordance with one or more example embodiments.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ may refer to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (for example, volatile or non-volatile memory device), may be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

A system, a computer-implemented method, and a computer program product are provided for validating a road object. Various embodiments are provided for receiving a road object observation associated with the road object. In various embodiments, the road object observation may comprise at least road object location data. Various embodiments are provided for identifying driving direction data associated with the received road object observation. Various embodiments are provided for obtaining administrative boundary data for a geographic region from a map database. In various embodiments, the administrative boundary data may correspond to at least one geographic administrative boundary in vicinity of the road object. In various embodiments, the geographic administrative boundary may be a virtual arbitrary shaped boundary that separates one administrative division from another administrative division of a country.

Various embodiments are provided for determining a distance between the road object and the at least one geographic administrative boundary. Various embodiments are provided for determining a relative position of the road object from the at least one geographic administrative boundary. In various embodiments, the relative position is determined as at least one of an upstream position with respect to the at least one geographic administrative boundary and a downstream position with respect to the at least one geographic administrative boundary. Various embodiments are provided for validating the road object based on at least two of the driving direction data, the distance between the road object and the at least one geographic administrative boundary and the relative position of the road object from the at least one geographic administrative boundary.

Various embodiments are provided for providing one or more navigation functions, based on the validation. In various embodiments, for providing one or more navigation functions, navigation instructions may be generated and/or the map database may be updated, based on the validation. Various embodiments are provided for generating navigation instructions for a vehicle, based on one or more of the road object location data, the relative position of the road object, a road sign data associated with a road sign which may be the road object, and the driving direction data. In various embodiments, the generated navigation instructions may reduce the multiple transitions of speed of the vehicle, while the vehicle is traveling from one administrative division to another administrative division. Accordingly, the unwanted conditions may be avoided. The unwanted conditions may include road accidents, increase in travel time, vehicle efficiency reduction, traffic congestions, environmental pollutions, and the like. The generated navigation instructions may be used to provide the one or more navigation functions such as vehicle speed guidance, vehicle speed handling and/or control, providing a route for navigation (e.g., via a user interface), localization, route determination, lane level speed determination, and the like. In some embodiments, the map database may be updated to reflect the changes in the administrative boundary and to provide most up-to-date administrative boundary data. In yet other embodiments, the map database may be updated to reflect the correct road object value, such as a correct speed limit value associated with a road sign and provide most up-to-date road object database.

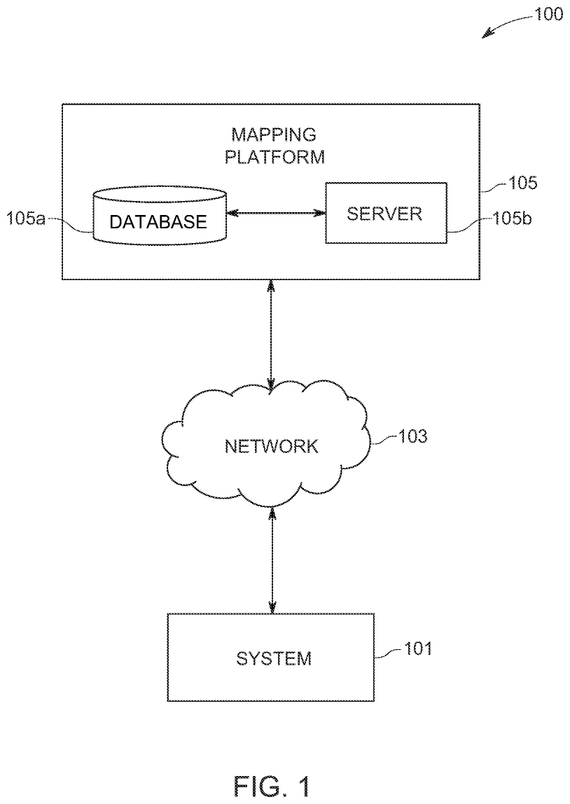

FIG. 1 illustrates a block diagram 100 showing an example architecture of a system 101 for validating a road object, in accordance with one or more example embodiments. As illustrated in FIG. 1, the block diagram 100 may comprise the system 101, a network 103, and a mapping platform 105. The mapping platform 105 may further comprise a map database 105a (also referred to as a geographic database 105a) and a server 105b. In various embodiments, the system 101 may be onboard a vehicle, such as the system 101 may be a navigation system installed in the vehicle for validating the road object. In various embodiments, the vehicle may be an autonomous vehicle, a semiautonomous vehicle, or a manual vehicle. In some embodiments, the system 101 may be the server 105b of the mapping platform 105 and therefore may be co-located with or within the mapping platform 105. In some other embodiments, the system 101 may be an OEM (Original Equipment Manufacturer) cloud. In such an embodiment, the system 101 is configured to anonymize the data about the vehicle in which the system 101 is installed and then transmit the any vehicle related data (such as a road object observation) to the mapping platform 105 for further processing. In some embodiments, this anonymization is done by the mapping platform 105 itself, after receiving such data from the system 101. The system 101 may be communicatively coupled with the mapping platform 105 over the network 103.

The network 103 may be wired, wireless, or any combination of wired and wireless communication networks, such as cellular, Wi-Fi, internet, local area networks, or the like. In some embodiments, the network 103 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., worldwide interoperability for microwave access (WiMAX), Long Term Evolution (LTE) networks (for e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

The system 101 may communicate with the mapping platform 105, via the network 103, where the mapping platform 105 may comprise the map database 105a for storing map data, and the processing server 105b for carrying out the processing functions associated with the mapping platform 105. The map database 105a may store node data, road segment data or link data, point of interest (POI) data, administrative boundary data, road obstacles related data, traffic objects related data, posted signs related data, such as road sign data, location data associated with the road sign data, or the like. The map database 105a may also include cartographic data and/or routing data. According to some example embodiments, the road segment data records may be links or segments representing roads, streets, or paths, as may be used in calculating a route or recorded route information for determination of one or more personalized routes. The node data may be end points corresponding to the respective links or segments of road segment data. For example, the node data may represent data for intersections. The road/link data and the node data may represent a road network, such as used by vehicles, for example, cars, trucks, buses, motorcycles, and/or other entities.

Optionally, the map database 105a may contain path segment and node data records or other data that may represent pedestrian paths or areas in addition to or instead of the vehicle road record data, for example. The road/link segments and nodes may be associated with attributes, such as geographic coordinates, legal travel directions (travel directions that the vehicles should follow while traveling on the road/link segments), lane level speed profile (historically derived speed limits for a lane), lane level maneuver pattern (lane change patterns at intersections), and other navigation related attributes such as administrative boundary records, road object records, POI records and the like. The administrative boundary records comprise geographic administrative boundaries (hereinafter, administrative boundaries) for different administrative divisions of a country. For example, the administrative boundaries may represent the country as the divided administrative divisions. The administrative division may include at least one of a built-up area (BUA), a non-built-up area (Non-BUA), an in-town area, an out-of-town area, an in-city area, an out-of-city area, a census designated area (CDA) and the like. The POI records includes POIs associated with the road segments and/or nodes. The POIs includes fueling stations, hotels, restaurants, museums, stadiums, offices, auto repair shops, buildings, stores, parks, etc. The map database 105a may additionally include data about places, such as cities, towns, or other communities, and other geographic features such as bodies of water, mountain ranges, etc. Such place or feature data may be part of the administrative boundary records or may be associated with the administrative boundary records (such as data points used for displaying or representing one or more cities and their corresponding boundaries). In addition, the map database 105a may include event data (e.g., traffic incidents, construction activities, scheduled events, unscheduled events, etc.) associated with the administrative boundary records or other records of the map database 105a. The map database 105a may additionally include data related to road objects and their geographic coordinates as the road object records. The road objects may include road signs, road obstacles, traffic objects and the like. The road object records may be associated with the road segments and/or with the other records of the map database 105a.

In one embodiment, the map or geographic database 105a may be maintained by a content provider in association with the mapping platform 105 (e.g., a map developer). The map developer may collect geographic data to generate and enhance the geographic database 105a. There may be different ways used by the map developer to collect data. These ways may include obtaining data from other sources, such as municipalities or respective geographic authorities. In addition, the map developer may employ field personnel to travel by vehicle (e.g., vehicles and/or user terminals) along roads throughout the geographic region to observe features and/or record information about them, for example. Also, remote sensing, such as aerial or satellite photography, may be used.

The geographic map database 105a may be a master geographic database stored in a format that facilitates updating, maintenance, and development. For example, the master geographic database or data in the master geographic database may be in an Oracle spatial format or other spatial format, such as for development or production purposes. The Oracle spatial format or development/production database may be compiled into a delivery format, such as a geographic data files (GDF) format. The data in the production and/or delivery formats may be compiled or further compiled to form geographic database products or databases, which may be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle or a user terminal, for example. The navigation-related functions may correspond to vehicle navigation, pedestrian navigation, or other types of navigation. The compilation to produce the end user databases may be performed by a party or entity separate from the map developer. For example, a customer of the map developer, such as a navigation device developer or other end user device developer, can perform compilation on a received geographic database in a delivery format to produce one or more compiled navigation databases.

The processing server 105b may comprise one or more processors configured to process requests received from the system 101. The processor may fetch map data from the map database 105a and transmit the same to the system 101 in a format suitable for use by the system 101. In some example embodiments, as disclosed in conjunction with the various embodiments disclosed herein, the system 101 may be used to validate the road object.

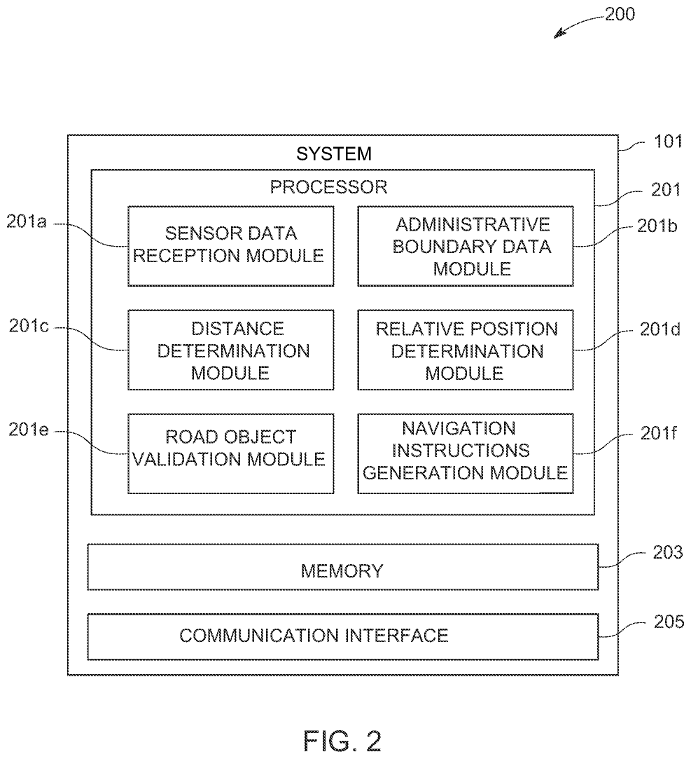

FIG. 2 illustrates a block diagram 200 of the system 101 for validating the road object, in accordance with one or more example embodiments. The system 101 may include at least one processor 201, a memory 203, and at least one communication interface 205. Further, the system 101 may comprise a sensor data reception module 201a, an administrative boundary data module 201b, a distance determination module 201c, a relative position determination module 201d, a road object validation module 201e, and a navigation instructions generation module 201f. In various embodiments, the sensor data reception module 201a may be configured to receive at least one road object observation associated with the road object. The road object observation may comprise at least road object location data. Additionally, the sensor data reception module 201a may be configured to identify driving direction data associated with the received road object observation. The administrative boundary data module 201b may be configured to obtain administrative boundary data for a geographic region from the map database 105a. The administrative boundary data may correspond to at least one geographic administrative boundary that is in vicinity of the road object. The distance determination module 201c may be configured to determine a distance between the road object and the at least one geographic administrative boundary. The relative position determination module 201d may be configured to determine a relative position of the road object from the at least one geographic administrative boundary. The road object validation module 201e may be configured to validate the road object based on various criteria such as the driving direction data, the distance between the road object and the at least one geographic administrative boundary, and the relative position of the road object from the at least one geographic administrative boundary. The navigation instructions generation module 201f may be configured to generate navigation instructions, based on the validation.

According to some embodiments, each of the modules 201a-201f may be embodied in the processor 201. The processor 201 may retrieve computer program code instructions that may be stored in the memory 203 for execution of computer program code instructions, which may be configured for validating the road object.

The processor 201 may be embodied in a number of different ways. For example, the processor 201 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 201 may include one or more processing cores configured to perform independently. A multi-core processor may enable multiprocessing within a single physical package. Additionally or alternatively, the processor 201 may include one or more processors configured in tandem via the bus to enable independent execution of instructions, pipelining and/or multithreading.

Additionally or alternatively, the processor 201 may include one or more processors capable of processing large volumes of workloads and operations to provide support for big data analysis. In an example embodiment, the processor 201 may be in communication with a memory 203 via a bus for passing information to mapping platform 105. The memory 203 may be non-transitory and may include, for example, one or more volatile and/or non-volatile memories. In other words, for example, the memory 203 may be an electronic storage device (for example, a computer readable storage medium) comprising gates configured to store data (for example, bits) that may be retrievable by a machine (for example, a computing device like the processor 201). The memory 203 may be configured to store information, data, content, applications, instructions, or the like, for enabling the system 101 to carry out various functions in accordance with an example embodiment of the present invention. For example, the memory 203 may be configured to buffer input data for processing by the processor 201. As exemplarily illustrated in FIG. 2, the memory 203 may be configured to store instructions for execution by the processor 201. As such, whether configured by hardware or software methods, or by a combination thereof, the processor 201 may represent an entity (for example, physically embodied in circuitry) capable of performing operations according to an embodiment of the present invention while configured accordingly. Thus, for example, when the processor 201 is embodied as an ASIC, FPGA or the like, the processor 201 may be specifically configured hardware for conducting the operations described herein. Alternatively, as another example, when the processor 201 is embodied as an executor of software instructions, the instructions may specifically configure the processor 201 to perform the algorithms and/or operations described herein when the instructions are executed. However, in some cases, the processor 201 may be a processor specific device (for example, a mobile terminal or a fixed computing device) configured to employ an embodiment of the present invention by further configuration of the processor 201 by instructions for performing the algorithms and/or operations described herein. The processor 201 may include, among other things, a clock, an arithmetic logic unit (ALU) and logic gates configured to support operation of the processor 201.

In some embodiments, the processor 201 may be configured to provide Internet-of-Things (IoT) related capabilities to users of the system 101, where the users may be a traveler, a driver of the vehicle and the like. In some embodiments, the users may be or correspond to an autonomous or semi-autonomous vehicle. The IoT related capabilities may in turn be used to provide smart navigation solutions by providing real time updates to the users to take pro-active decision on, speed determination, lane-level speed determination, turn-maneuvers, lane changes, overtaking, merging and the like, big data analysis, and sensor-based data collection by using the cloud based mapping system for providing navigation recommendation services to the users. The system 101 may be accessed using the communication interface 205. The communication interface 205 may provide an interface for accessing various features and data stored in the system 101. For example, the communication interface 205 may comprise I/O interface which may be in the form of a GUI, a touch interface, a voice enabled interface, a keypad and the like. For example, the communication interface 205 may be a touch enabled interface of a navigation device installed in a vehicle, which may also display various navigation related data to the user of the vehicle. Such navigation related data may include information about upcoming conditions on a route, route display, alerts about vehicle speed, and the like.

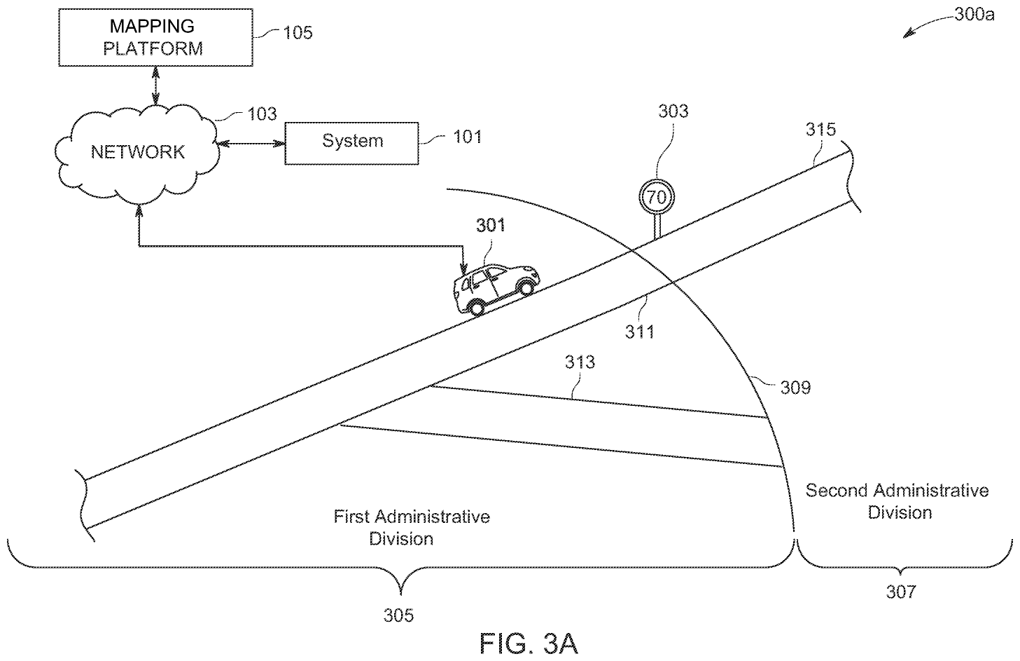

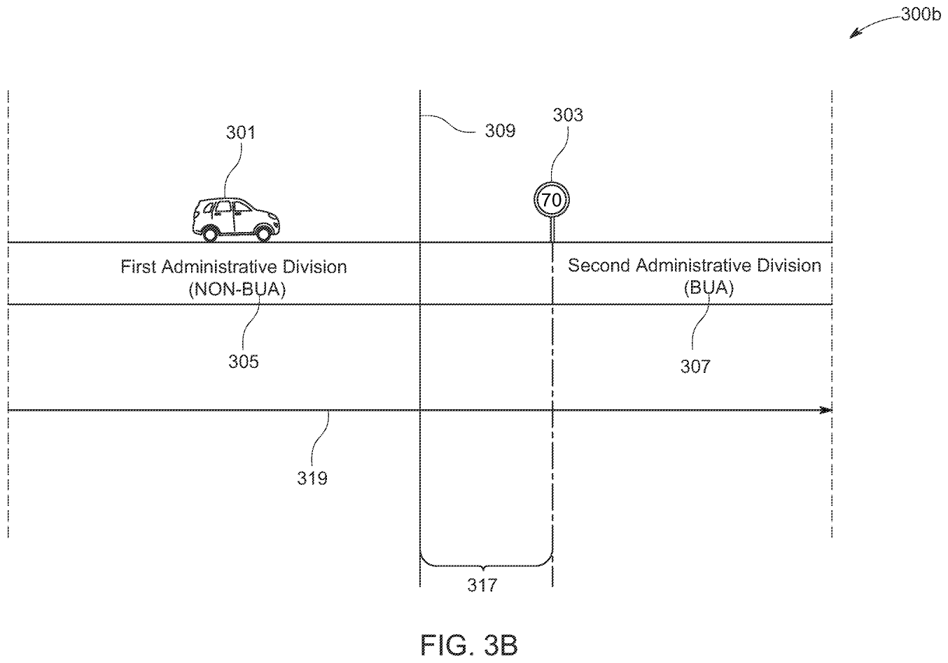

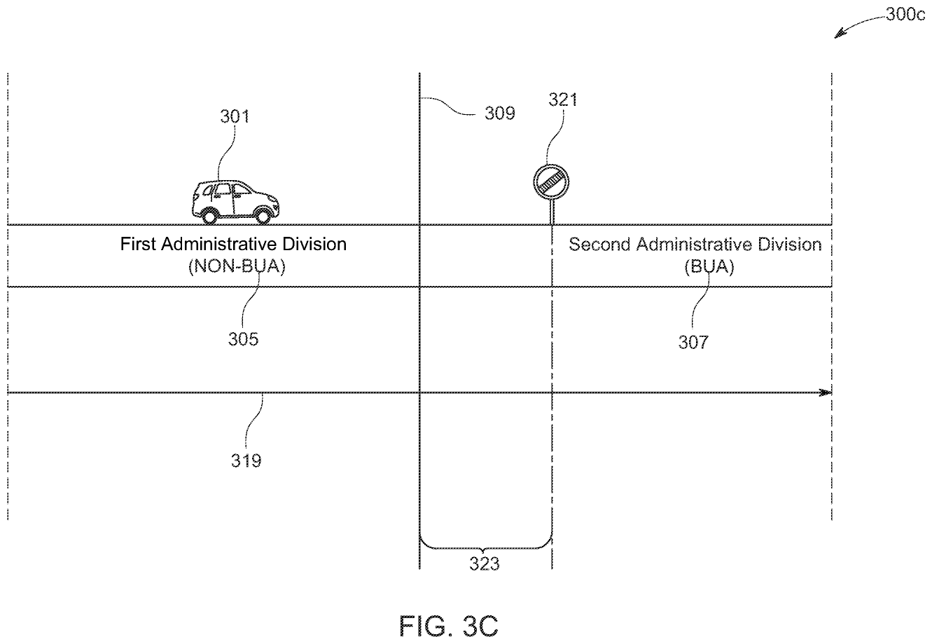

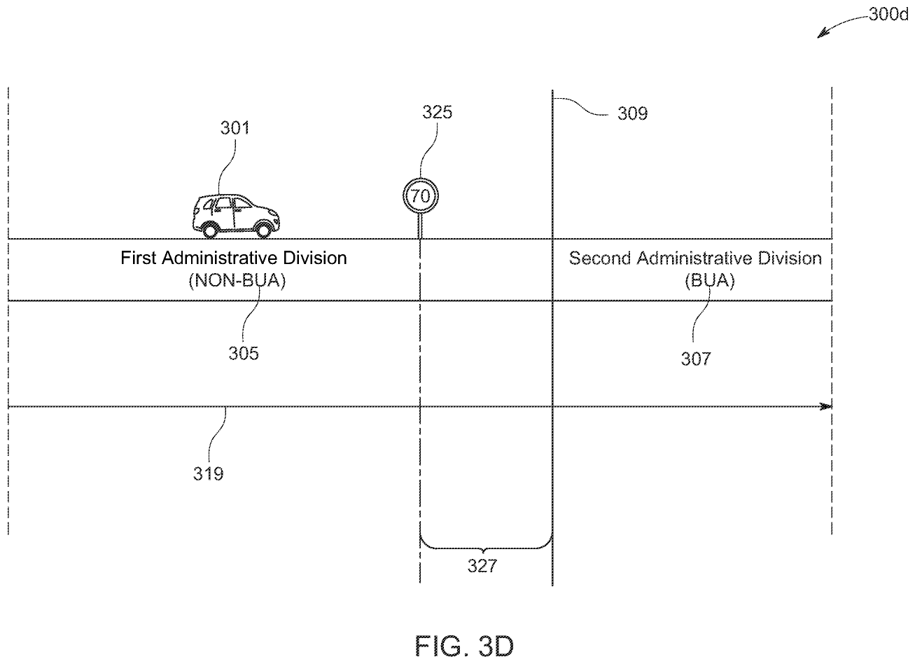

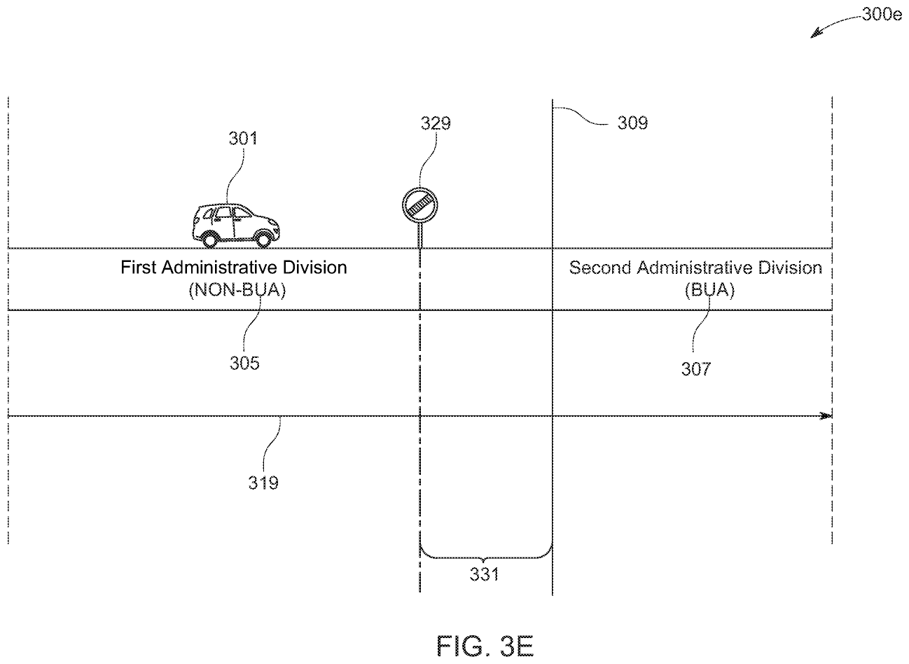

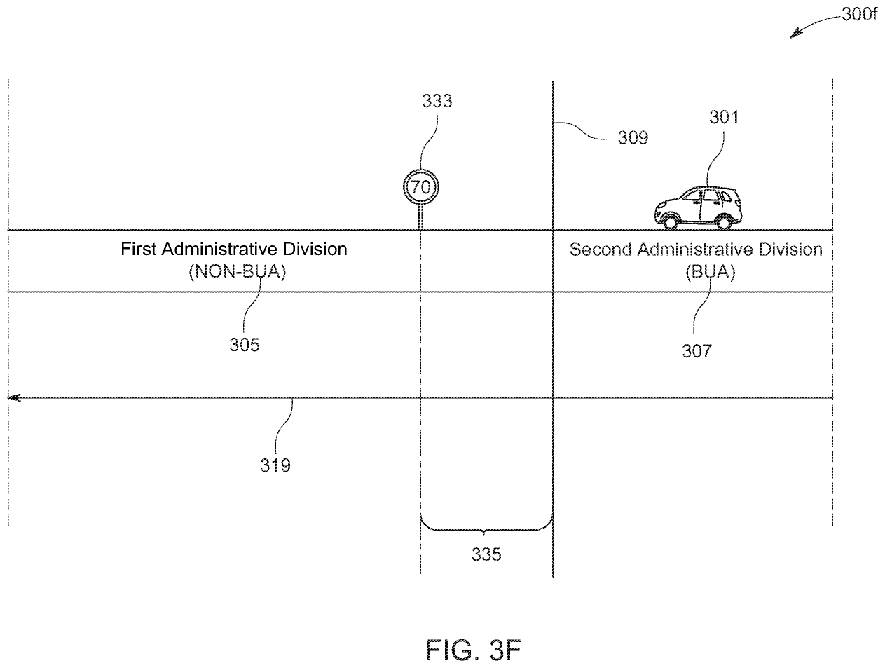

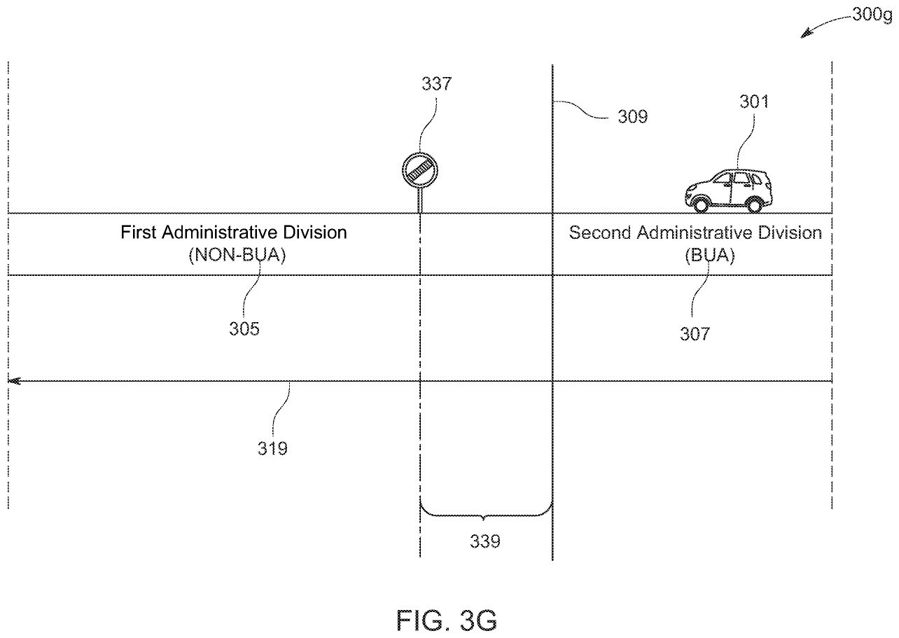

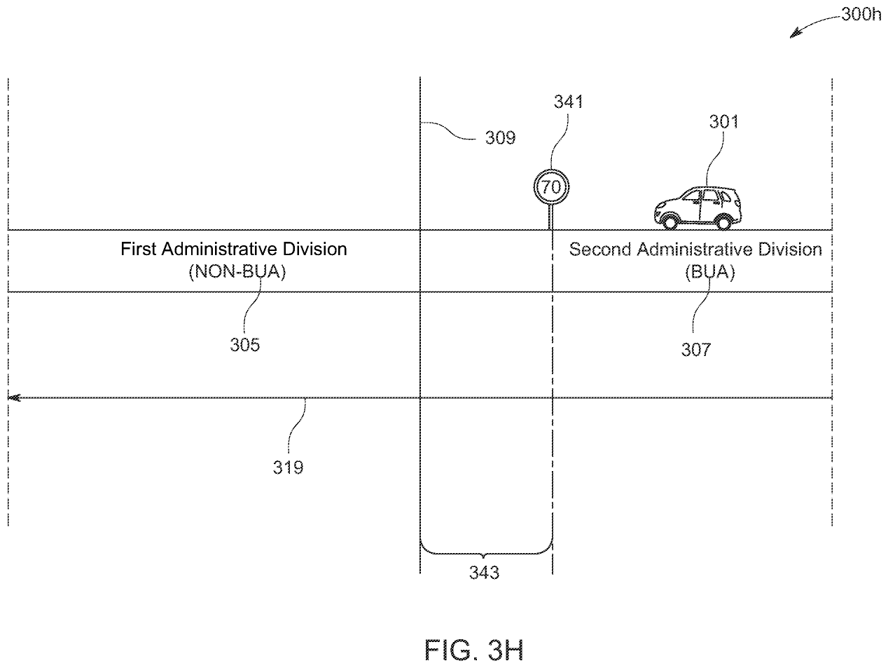

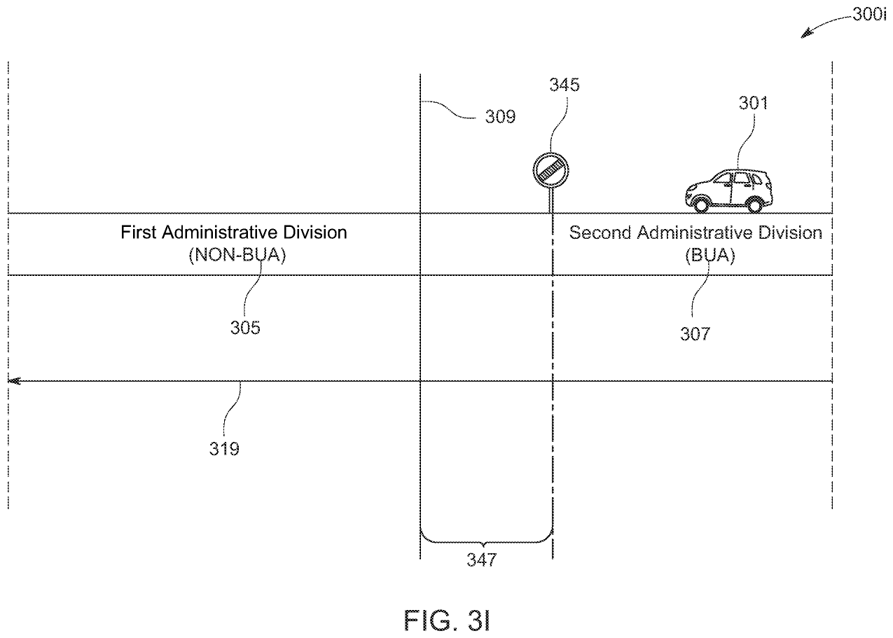

FIG. 3A illustrates an exemplary working environment 300a of the system 101 for validating a road object 303, in accordance with one or more example embodiments. The working environment 300a includes the system 101, the network 103, the mapping platform 105, a vehicle 301, the road object 303, a first administrative division 305, a second administrative division 307, a geographic administrative boundary 309 (hereinafter, an administrative boundary 309), one or more links 311 and/or 313 associated with the first administrative division 305, and one or more links 315 associated with the second administrative division 307. In various embodiments, the road object 303 may be at least one of a road sign, a road obstacle, a traffic object, and the like. In various embodiments, the road sign may comprise a speed limit sign, a speed limit end sign, an end of restrictions sign, a route guidance sign, a parking sign, a destination sign, a warning sign and the like. In various embodiments, the road obstacle may comprise a road divider, a road work object, and the like. In various embodiments, the traffic object may comprise a traffic cone, a guide rail, and the like. As illustrated in the FIG. 3A, the vehicle 301 may be traveling from the first administrative division 305 to the second administrative division 307. The vehicle 301 may include a motor vehicle, a non-motor vehicle, an automobile, a car, a scooter, a truck, a van, a bus, a motorcycle, a bicycle, a Segway, and/or the like. The vehicle 301 may be an autonomous vehicle, a semi-autonomous vehicle or a manual vehicle. As used herein, the autonomous vehicle may be a vehicle that is capable of sensing its environment and operating without human involvement. For instance, the autonomous vehicle may be a self-driving car and the like.

Each of the first administrative division 305 and the second administrative 307 may be at least one of the built-up area, the non-built-up area, the in-town area, the out-of-town area, the in-city area, the out-of-city area, the census designated area (CDA) and the like. For example, the first administrative division 305 may comprise the links 311 and 313. For example, the second administrative division 307 may comprise the link 315. As used herein, ‘link’ (e.g. the links 311, 313, 315) may be a road segment between nodes (each node may represent an intersection). In various embodiments, the first administrative division 305 and the second administrative division 307 may be separated by an arbitrary shaped boundary, for instance, the administrative boundary 309. To that end, the administrative boundary 309 is associated with at least one of the first administrative division 305 and the second administrative division 307. According to some embodiments, the road object 303 may be located on the administrative boundary 309 or may be located near the administrative boundary 309 to aid the vehicle 301 to travel in the second administrative division 307. For instance, the road object 303 may be located within a threshold distance of hundred meters from the administrative boundary 309.

However, in some cases, the location (also referred to as a road object location) of the road object 303 may be identified wrongly due to changes in the administrative boundary 309 (e.g., expansion of village, town, city or the like), GPS (Global Positioning System) errors (e.g., GPS fluctuations), sight distance effects (e.g., sight distance from the vehicle 301 to the location of the road object 303), outdated map data, and the like. As a result, a short region (for instance, a short road segment) may be formed between the location of the road object 303 and the administrative boundary 309. Due to the formation of the short region, the vehicle 301 may have multiple transitions in terms of an attribute, such as the speed of the vehicle 301, while traveling from the first administrative division 305 to the second administrative division 307. For instance, if the road object 303 is the speed limit sign, the vehicle 301 may need: to travel with a first speed value that is associated with the link 311 on the first administrative division 305; to travel with a second speed value that is default speed associated with the second administrative division 307 after reaching the administrative boundary 309 and until reaching the road object 303; and to travel with a third speed value (e.g. a speed value associated with the road object 303) after reaching the location of the road object 303. As a result of the multiple transitions in speed values, the vehicle 301 may end-up with unwanted conditions such as road accidents, increase in travel time, reduction in efficiency of the vehicle 301, traffic congestions, environmental pollutions, and the like.

To that end, the system 101 is provided to validate the road object 303 and accurately do at least one: generate navigation instructions for the vehicle 301, while traveling from the first administrative division 305 to the second administrative division 307 such that the multiple transitions of an attribute value, such as a first attribute value and a second attribute value, which relate to the road object, and are speed limit values when the road object is a speed limit sign, are reduced. Accordingly, the system 101 avoids the unwanted conditions. The system 101 is configured to validate the road object 303 and to accurately generate the navigation instructions using the validated road object 303 while traveling from the first administrative division 305 to the second administrative division 307 as is further explained in detail with various scenarios in the detailed description of FIG. 3B-FIG. 3I.

FIG. 3B illustrates a first working environment 300b of the system 101 for validating the road object 303, in accordance with one or more example embodiments. The first working environment 300b includes a scenario that is showing the road object 303 indicative of the speed limit sign; the road object 303 is located on the second administrative division 307; and the vehicle 301 is traveling from the first administrative division 305 (e.g., Non-BUA) to the second administrative division 307 (e.g., BUA). As previously described, a short region 317 (also referred to as a short road segment 317) may be formed between the administrative boundary 309 and the location associated with the road object 303, due to at least one of: the change in the administrative boundary 309, the GPS errors, the sight distance effects, the outdated map data and the like.

The vehicle 301 may acquire at least one road object observation associated with the road object 303 and a driving direction data 319 while traveling. To that end, the vehicle 301 may be equipped with various sensors for collecting the road object observations associated with the road object 303 and the driving direction data 319. For instance, the sensor of the vehicle 301 includes a radar system, a LiDAR system, a global positioning sensor for gathering location data (e.g., GPS), image sensors, temporal information sensors, orientation sensors augmented with height sensors, tilt sensors, and the like. The road object observation associated with the road object 303 may include road object location data (also referred to as a location data associated with the road object 303) and road object data (e.g. a road object value, a road object type, and the like) associated with the road object 303. In various embodiments, the road object location data may be used to determine the road object location (also referred to as the location of the road object 303). In various embodiments, the road object data may be used to determine the road object value, the road object type, and the like. Additionally, the road object observation associated with the road object 303 may include a timestamp data indicating a time instance at which the road object observation was collected. The driving direction data 319 may include a direction data in which the vehicle 301 through which the road object observation is captured is traveling.

In various embodiments, the system 101 may be configured to receive the road object observation associated with the road object 303. For instance, the sensor data reception module 201a of the system 101 may receive the road object observation associated with the road object 303. In various embodiments, the system 101 may be configured to identify the driving direction data 319 associated with the received road object observation. For instance, the system 101 may identify the driving direction data 319 of the vehicle 301, while the road object observation was made. In some embodiments, the system 101 may receive the road object observation associated with the road object 303 along with the driving direction data 319. In various embodiments, the system 101 may be configured to determine the administrative boundary 309 associated with the road object 303, based on the location data associated with the road object 303 and the map database 105a. For instance, the administrative boundary data module 201b of the system 101 may determine the administrative boundary 309 associated with the road object 303, based on the location data associated with the road object 303 and the map database 105a. In some embodiments, the system 101 may determine the administrative boundary 309 associated with the road object 303 by map-matching, using the map database 105a, the location data associated with the road object 303. In some other embodiments, the system 101 may obtain, from the map database 105a, the administrative boundary data (e.g. the administrative boundary record) for a geographic region or the location data associated with the road object 303. For instance, the system 101 may use the location data associated with the road object 303 to map-match the road object 303 and obtain the administrative boundary data for the geographic region that is in the vicinity of the road object 303. To that end, the obtained administrative boundary data may comprise at least one administrative boundary (for instance, the administrative boundary 309) that is in the vicinity of the road object 303. As used herein, the geographic region may be a region that at least includes the road object 303, the one or more administrative divisions, such as the first administrative division 305 and the second administrative division 307, and the administrative boundary 309 that virtually separates the administrative divisions.

In various embodiments, the system 101 may be configured to validate the road object 303 based on a distance between the location data associated with the road object 303 and the administrative boundary 309. For instance, the road object validation module 201e may validate the road object 303 based on the distance between the location data associated with the road object 303 and the administrative boundary 309. To that end, the system 101 may determine the distance between the location data associated with the road object 303, which indicates a point location (such as map-matched location of the road object 303 on the link 315) for the road object 303 with respect to the map of the geographic region in which the road object 303 is located, and the administrative boundary 309. The system 101 may identify a threshold distance or a threshold range associated with distance between the road object 303 and the administrative boundary 309. The system 101 may compare the distance between the location data associated with the road object 303 and the administrative boundary 309 with the threshold range or the threshold distance. In various embodiments, the threshold range or the threshold distance may be determined by experimentation and the like. For instance, the threshold range may be a range from hundred meters to three hundred meters. For instance, the threshold distance may be two hundred meters.

In various embodiments, the system 101 may identify the road object 303 as a valid road object, if the distance between the location data associated with the road object 303 and the administrative boundary 309 is within the threshold range. As used herein, the valid road object may indicate that the road object 303 is located within the threshold range from the administrative boundary 309 and that the location of the road object 303 is an updated location based to consider for deriving the attribute value associated with the road object 303 and apply it for navigation of the vehicle 301. In some embodiments, the system 101 may identify the road object 303 as the valid road object if the distance between the location data associated with the road object 303 and the administrative boundary 309 is less than the threshold distance. In various embodiments, the system 101 may identify the road object 303 as invalid road object, if the distance between the location data associated with the road object 303 and the administrative boundary 309 is not within the threshold range. In some embodiments, the system 101 may identify the road object 303 as the invalid road object, if the distance between the location data associated with the road object 303 and the administrative boundary 309 is more than the threshold distance. If the road object 303 is identified as the invalid road object, the system 101 may generate a request to manually verify whether the administrative boundary 309 as changed.

If the road object 303 is identified as the valid road object based on the previously defined distance criteria, the system 101 may be configured to continue with validation procedure further to include more checks on the road object 303 data for more accuracy in validating the road object 303. The system 101 may then be configured to determine a relative position of the road object 303 with respect to the administrative boundary 309, based on the location data associated with the road object 303. For instance, the relative position determination module 201d determines the relative position of the valid road object with respect to the administrative boundary 309. In various embodiments, the system 101 may determine the relative position as at least one of: an upstream position with respect to the administrative boundary 309; and a downstream position with respect to the administrative boundary 309. The upstream position with respect to the administrative boundary 309 may indicate that the road object 303 is located in the first administrative division 305. In other word, the upstream position with respect to the administrative boundary 309 may indicate that the road object 303 is located before traversing the administrative boundary 309. The downstream position with respect to the administrative boundary 309 may indicate that the road object 303 is located in the second administrative division 307. In other words, the downstream position with respect to the administrative boundary 309 may indicate that the road object 303 is located after traversing the administrative boundary 309.

In some embodiments, the system 101 may be further configured to validate the road object 303, based on the relative position of the road object 303 and the driving direction data 319. For instance, validating the road object 303 based on the relative position of the road object 303 may be include checking whether the road object 303 is located in the first administrative division 305 (e.g. the upstream position) or the road object 303 is located in the second administrative division 307 (e.g. the downstream position). For instance, validating the road object 303 based on the driving direction data 319 may include checking whether the vehicle 301 is transitioning from the first administrative division 305 to the second administrative division 307 or the vehicle 301 is transitioning from the second administrative 307 to the first administrative division 305.

In some embodiments, if the road object 303 is located in the second administrative division 307, the system 101 determines the location data associated with the road object 303 in the second administrative division 307 as a new administrative boundary. Similarly, in some embodiments, if the road object 303 is located in the first administrative division 305, the system 101 determines the location data associated with the road object 303 in the first administrative division 305 as the new administrative boundary. The new administrative boundary may indicate the change in the administrative boundary 309. In some example embodiments, the system 101 may update the map database 105a about the change in the administrative boundary 309. For instance, the system 101 may update the map database 105a as the administrative boundary 309 is changed to the new administrative boundary (e.g. the location data of the road object 303). In other words, the system 101 may update the map database 105a as the first administrative division 305 is changed to a first geographic region. For instance, the first geographic region may include the first administrative division 305 and the short region 317. Further, the system may update the map database 105a as the second administrative division 307 is changed to a second geographic region. For instance, the second geographic region may be the second administrative division 307 excluding the short region 317. In some other example embodiments, the system 101 may update the map database 105a with the location data associated with the road object 303, the relative position of the road object 303 with respect to the administrative boundary 309, the road object data associated with the road object 303.

In various embodiments, the system 101 may be configured to generate the navigation instructions for the vehicle 301, based on one or more of the new administrative boundary, the road object data associated with the road object 303, and the driving direction data 319. To that end, the system 101 may be configured to determine the road object data associated with the road object 303. For determining the road object data associated with the road object 303, the system 101 may identify the road object value and the road object type associated with the received road object observation. If the road object type corresponds to the speed limit sign, the system 101 may generate the navigation instructions for the vehicle 301, based on the new administrative boundary (e.g. the road object location data) and the road object value. For generating the navigation instructions, the system 101 may determine a first attribute value associated with the received road object observation. For instance, the first attribute value may be a speed value associated with the vehicle 301, when the road object observation was received. Further, the system 101 may determine a second attribute value and a third attribute value for the received object observation, based on the new administrative boundary (e.g. the road object location data), the first attribute value and the road object value. The second attribute value may be associated with the first geographic region. For instance, the second attribute value may be associated with the first administrative division 305 and the short region 317. The third attribute value may be associated with the second geographic region. For instance, the third attribute may be associated with the second administrative division 307 excluding the short region 317. In various embodiments, the second attribute may be same as the first attribute value and the third attribute value may be same as the road object value, when the road object is identified as the valid road object and the road object type corresponds to the speed limit sign. Further, the system 101 may generate, for the vehicle 301, the navigation instructions to apply the second attribute value on the first geographic region (e.g. until reaching the road object location) and to apply the third attribute value on the second geographic region (e.g. after reaching the road object location).

In some other example embodiments, the system 101 generate, for the vehicle 301, the navigation instructions to: propagate the vehicle 301 with a speed limit value associated with the first administrative division 305 while traveling on the first administrative division 305; not to change the speed limit value associated with the vehicle 301 after reaching the administrative boundary 309 until reaching the new administrative boundary (e.g. the location associated with the road object 303); and propagate the vehicle 301 with the road object value (e.g. speed limit value of 70 kmph) associated with the road object 303 after reaching the new administrative boundary. In other words, the system 101 may generate the navigation instructions to change the speed value associated with the vehicle 301 to the road object data associated with the road object 303 after reaching the new administrative boundary.

Further, in some embodiments, the system 101 may update the map database 105a based on the generated navigation instructions. In some example embodiments, the system 101 may update the map database 105a with the second attribute value associated with the first geographic region and the third attribute value associated with the second geographic region. In some other example embodiments, the system 101 may update the map database 105a with the generated navigation instructions associated with the short region 317. For example, the navigation instructions associated with the short region 317 may be not to change the speed limit value associated with the vehicle 301 after reaching the administrative boundary 309 until reaching the new administrative boundary.

In this way, the system 101 validates the road object 303 and generates the navigation instructions to the vehicle 301 such that the vehicle 301 transits (changes the state of the vehicle 301) only once at the new administrative boundary (e.g. at the location of the road object 303). Accordingly, the system 101 reduces the multiple transitions of speed value while the vehicle 301 is traveling from one administrative division to another administrative division. Therefore, the system 101 avoids the unwanted conditions such as road accidents, increase in travel time, vehicle efficiency reduction, traffic congestions, environmental pollutions, and the like. Further, the system 101 may use the updated map database 105a and/or the generated navigation instructions to provide one or more navigation instructions. Some non-limiting examples of the navigation functions includes providing vehicle speed guidance, vehicle speed handling and/or control, providing a route for navigation (e.g., via a user interface), localization, route determination, lane level speed determination, operating the vehicle along a lane level route, route travel time determination, lane maintenance, route guidance, provision of traffic information/data, provision of lane level traffic information/data, vehicle trajectory determination and/or guidance, route and/or maneuver visualization, and/or the like.

Here for the purpose of explanation, the road object 303 is considered as the speed limit sign. For instance, the road object 303 may be at least one of the speed limit sign, the speed limit end sign, the end of restrictions sign, the route guidance sign, the parking sign, the destination sign, the warning sign and the like. When the road object 303 is the speed limit end sign, the system 101 may validate the road object and generate the navigation instructions as explained in the detailed description of FIG. 3C.

FIG. 3C illustrates a second working environment 300c of the system 101 for validating a road object 321, in accordance with one or more example embodiments. The second working environment 300c includes a scenario that is showing the road object 321 indicative of a speed limit end sign; the road object 321 located on the second administrative division 307; and the vehicle 301 is traveling from the first administrative division 305 (e.g. Non-BUA) to the second administrative division 307 (e.g. BUA). As explained in FIG. 3A, a short region 323 (also referred to as a short road segment 323) may be formed between the administrative boundary 309 and the location associated with the road object 321, due to at least one of the change in the administrative boundary 309, the GPS errors, the sight distance effects, the outdated map data and the like.

In various embodiments, the system 101 may receive the road object observation associated with the road object 321 and identify the driving direction data 319. In various embodiments, the system 101 may obtain the administrative boundary 309 that is in the vicinity of the road object 321. In various embodiments, the system 101 may be configured to validate the road object 321 based on a distance between the location data associated with the road object 321 and the administrative boundary 309. For instance, the system 101 may compare the distance between the location data associated with the road object 321 and the administrative boundary 309 with the threshold range (e.g., the range of 100 meters-300 meters).

If the distance between the location data associated with the road object 321 and the administrative boundary 309 is within the threshold range, the system 101 may identify the road object 321 as the valid road object. Once the road object 321 is identified as the valid road object, the system 101 may determine the relative position of the road object 321 with respect to the administrative boundary 309. Further, the system 101 may validate the road object 321 based on the relative position of the road object 321, and the driving direction data 319. For instance, validating the road object 321 based on the relative position of the road object 321 may be include checking whether the road object 321 is located in the first administrative division 305 or the road object 321 is located in the second administrative division 307. For instance, validating the road object 321 based on the driving direction data 319 may include checking whether the vehicle 301 is transitioning from the first administrative division 305 to the second administrative division 307 or the vehicle 301 is transitioning from the second administrative 307 to the first administrative division 305.

If the road object 321 is located on the second administrative division 307, the system 101 may determine the location associated with the road object 321 in the second administrative division 307 as the new administrative boundary. In some example embodiments, the system 101 may update the map database 105a with the new administrative boundary. For instance, the system 101 may update the map database 105a to include that the administrative boundary 309 is changed to the new administrative boundary (e.g. the location data of the road object 321). In other words, the system 101 may update the map database 105a as the first administrative division 305 is changed to the first geographic region. For instance, the first geographic region may include the first administrative division 305 and the short region 323. Further, the system may update the map database 105a as the second administrative division 307 is changed to the second geographic region. For instance, the second geographic region may be the second administrative division 307 excluding the short region 323.

In various embodiments, the system 101 may be configured to generate the navigation instructions for the vehicle 301, based on one or more of the new administrative boundary, the road object data associated with the road object 321, and the driving direction data 319. To that end, the system 101 may be configured to determine the road object data associated with the road object 321. For determining the road object data associated with the road object 321, the system 101 may identify the road object value and the road object type associated with the received road object observation. If the road object type is identified as different from the speed limit sign (e.g. the speed limit end sign), the system 101 may be configured to determine, using the driving direction data 319, whether the vehicle 301 is transitioning from the first administrative division 305 (e.g. Non-BUA) to the second administrative division 307 (e.g. BUA) or the second administrative division 307 (e.g. BUA) to the first administrative division 305 (e.g. Non-BUA). In various embodiments, the driving direction data 319 may indicate that the vehicle 301 is transitioning from the first administrative division 305 (e.g. Non-BUA) to the second administrative division 307 (e.g. BUA) or the second administrative division 307 (e.g. BUA) to the first administrative division 305 (e.g. Non-BUA) based on the administrative boundary 309.

In response to determining the vehicle 301 is traveling from the first administrative division 305 (e.g. Non-BUA) to the second administrative division 307 (e.g. BUA), the system 101 may generate the navigation instructions for the vehicle 301. In some example embodiments, the system 101 may determine the first attribute value for generating the navigation instructions. For instance, the first attribute value may be the speed value associated with the vehicle 301, when the road object observation was received. Further, the system 101 may determine the second attribute value as the first attribute and the third attribute value as a default speed value associated with the second administrative division 307, when the road object 321 is the valid road object and the road object type is at least one of the speed limit end sign, the end of restriction sign, or the like. Furthermore, the system 101 may generate the navigation instructions to apply the second attribute value to the first geographic region and the third attribute value to the second geographic region. In some other example embodiments, the system 101 may generate, for the vehicle 301, the navigation instructions to: propagate the vehicle 301 with the speed limit value associated with the first administrative division 305 while traveling on the first administrative division 305; not to change the speed limit value associated with the vehicle 301 after reaching the administrative boundary 309 until reaching the new administrative boundary (e.g. the location associated with the road object 321); and propagate the vehicle 301 with a default speed value (e.g. speed limit value of 50 kmph) associated with the second administrative division 307 (e.g. BUA) after reaching the new administrative boundary. In other words, the system 101 may generate the navigation instructions to change the speed value associated with the vehicle 301 to the default speed value associated with the second administrative division 307 after reaching the new administrative boundary. For instance, the default speed value associated with the BUA may be 50 kmph.

Further, in some embodiments, the system 101 may update the map database 105a based on the generated navigation instructions. In some example embodiments, the system 101 may update the map database 105a with the second attribute value associated with the first geographic region and the third attribute value associated with the second geographic region. In some other example embodiments, the system 101 may update the map database 105a with the generated navigation instructions associated with the short region 323. For example, the navigation instructions associated with the short region 323 may be not to change the speed limit value associated with the vehicle 301 after reaching the administrative boundary 309 until reaching the new administrative boundary.

In this way, the system 101 validates the road object 321 and generates the navigation instructions to the vehicle 301 such that the multiple transitions of speed of the vehicle 301 are reduced while the vehicle 301 is traveling from one administrative division to another administrative division. Accordingly, the system 101 avoids the unwanted conditions. Here for the purpose of explanation, the road object 321 located on the second administrative division 307 is considered. For instance, the road object may be located on the first administrative division 305. When the road object is located on the first administrative 305, the system 101 may validate the road object and generate the navigation instructions as explained in the detailed description of FIG. 3D.

FIG. 3D illustrates a third working environment 300d of the system 101 for validating a road object 325, in accordance with one or more example embodiments. The third working environment 300d includes a scenario that is showing the road object 325 indicative of the speed limit sign; the road object 325 located on the first administrative division 305; and the vehicle 301 is traveling from the first administrative division 305 (e.g. Non-BUA) to the second administrative division 307 (e.g. BUA). As explained in FIG. 3A, a short region 327 (also referred to as a short road segment 327) may be formed between the administrative boundary 309 and the location associated with the road object 325, due to at least one of the change in the administrative boundary 309, the GPS errors, the sight distance effects, the outdated map data and the like.

In various embodiments, the system 101 may receive the road object observation associated with the road object 325 and identify the driving direction data 319. In various embodiments, the system 101 may obtain the administrative boundary 309 that is in the vicinity of the road object 325. In various embodiments, the system 101 may be configured to validate the road object 325 based on a distance between the location data associated with the road object 325 and the administrative boundary 309. For instance, the system 101 may compare the distance between the location data associated with the road object 325 and the administrative boundary 309 with the threshold range (e.g., the range of 100 meters-300 meters).

If the distance between the location data associated with the road object 325 and the administrative boundary 309 is within the threshold range, the system 101 may identify the road object 325 as the valid road object. Once the road object 325 is identified as the valid road object, the system 101 may further determine the relative position of the road object 325 with respect to the administrative boundary 309. Further, the system 101 may validate the road object 325 based on the relative position of the road object 325, and the driving direction data 319. For instance, validating the road object 325 based on the relative position of the road object 325 may be include checking whether the road object 325 is located in the first administrative division 305 or the road object 325 is located in the second administrative division 307. For instance, validating the road object 325 based on the driving direction data 319 may include checking whether the vehicle 301 is transitioning from the first administrative division 305 to the second administrative division 307 or the vehicle 301 is transitioning from the second administrative 307 to the first administrative division 305.

If the road object 325 is located in the first administrative division 305, the system 101 may determine the location associated with the road object 325 in the first administrative division 305 as the new administrative boundary. In some example embodiments, the system 101 may update the map database 105a with the new administrative boundary. For instance, the system 101 may update the map database 105a to include that the administrative boundary 309 is changed to the new administrative boundary (e.g. the location data of the road object 325). In other words, the system 101 may update the map database 105a as the first administrative division 305 is changed to the first geographic region. For instance, the first geographic region may be the first administrative division 305 excluding the short region 327. Further, the system 101 may update the map database 105a as the second administrative division 307 is changed to the second geographic region. For instance, the second geographic region may include the second administrative division 307 and the short region 327.

In various embodiments, the system 101 may be configured to generate the navigation instructions for the vehicle 301, based on one or more of the new administrative boundary, the road object data associated with the road object 325, and the driving direction data 319. To that end, the system 101 may be configured to determine the road object data associated with the road object 325. For determining the road object data associated with the road object 325, the system 101 may identify the road object value and the road object type associated with the received road object observation. If the road object type is identified as the speed limit sign, the system 101 generates the navigation instructions for the vehicle 301, based on the new administrative boundary and the road object value. In some example embodiments, the system 101 may determine the first attribute value for generating the navigation instructions. For instance, the first attribute value may be the speed value associated with the vehicle 301, when the road object observation was received. Further, the system 101 may determine the second attribute value as the first attribute and the third attribute value as the road object value of the road object 325, when the road object 325 is the valid road object and the road object type is the speed limit sign. Furthermore, the system 101 may generate the navigation instructions to apply the second attribute value to the first geographic region and the third attribute value to the second geographic region. In some other example embodiments, the system 101 may generate, for the vehicle 301, the navigation instructions to: propagate the vehicle 301 with the speed limit value associated with the first administrative division 305 until reaching the new administrative boundary; change the speed limit value associated with the vehicle 301 to the speed limit value associated with the road object 325 after reaching the new administrative boundary (e.g. the location associated with the road object 325) and until reaching the administrative boundary 309; and not to change the speed limit value associated with the vehicle 301 after reaching the administrative boundary 309. In other words, the system 101 may generate the navigation instructions to change the speed value associated with the vehicle 301 to the speed limit value associated with the road object 325 after reaching the new administrative boundary.

Further, in some embodiments, the system 101 may update the map database 105a based on the generated navigation instructions. In some example embodiments, the system 101 may update the map database 105a with the second attribute value associated with the first geographic region and the third attribute value associated with the second geographic region. In some other example embodiments, the system 101 may update the map database 105a with the generated navigation instructions associated with the short region 327. For example, the navigation instructions associated with the short region 327 may be to change the speed limit value associated with the vehicle 301 to the speed limit value associated with the road object 325 after reaching the new administrative boundary (e.g. the location associated with the road object 325) and until reaching the administrative boundary 309.

In this way, the system 101 validates the road object 325 and generates the navigation instructions to the vehicle 301 such that the multiple transitions of the vehicle 301 are reduced while the vehicle 301 is traveling from one administrative division to another administrative division. Accordingly, the system 101 avoids the unwanted conditions. Here for the purpose of explanation, the road object is considered as the speed limit sign. For instance, the road object may be the speed limit end sign. When the road object is the speed limit end sign, the system 101 may validate the road object and generate the navigation instructions as explained in the detailed description of FIG. 3E.

FIG. 3E illustrates a fourth working environment 300e of the system 101 for validating a road object 329, in accordance with one or more example embodiments. The fourth working environment 300e includes a scenario that is showing the road object 329 indicative of the speed limit end sign; the road object 329 located in the first administrative division 305; and the vehicle 301 is traveling from the first administrative division 305 (e.g., Non-BUA) to the second administrative division 307 (e.g., BUA). As explained in FIG. 3A, a short region 331 (also referred to as a short road segment 331) may be formed between the administrative boundary 309 and the location associated with the road object 329, due to at least one of the change in the administrative boundary 309, the GPS errors, the sight distance effects, the outdated map data and the like.

In various embodiments, the system 101 may receive the road object observation associated with the road object 329 and identify the driving direction data 319. In various embodiments, the system 101 may obtain the administrative boundary 309 that is in the vicinity of the road object 321. In various embodiments, the system 101 may be configured to validate the road object 329 based on a distance between the location data associated with the road object 329 and the administrative boundary 309. For instance, the system 101 may compare the distance between the location data associated with the road object 329 and the administrative boundary 309 with the threshold range (e.g., the range of 100 meters-300 meters).

If the distance between the location data associated with the road object 329 and the administrative boundary 309 is within the threshold range, the system 101 may identify the road object 329 as the valid road object. Once the road object 329 is identified as the valid road object, the system 101 may determine the relative position of the road object 329 with respect to the administrative boundary 309. Further, the system 101 may validate the road object 329 based on the relative position of the road object 329, and the driving direction data 319. For instance, validating the road object 329 based on the relative position of the road object 329 may be include checking whether the road object 329 is located in the first administrative division 305 or the road object 329 is located in the second administrative division 307. For instance, validating the road object 329 based on the driving direction data 319 may include checking whether the vehicle 301 is transitioning from the first administrative division 305 to the second administrative division 307 or the vehicle 301 is transitioning from the second administrative 307 to the first administrative division 305.

If the road object 329 is located in the first administrative division 305, the system 101 may determine the location associated with the road object 329 in the first administrative division 305 as the new administrative boundary. In some example embodiments, the system 101 may update the map database 105a with the new administrative boundary. For instance, the system 101 may update the map database 105a to include that the administrative boundary 309 is changed to the new administrative boundary (e.g. the location data of the road object 329). In other words, the system 101 may update the map database 105a as the first administrative division 305 is changed to the first geographic region. For instance, the first geographic region may be the first administrative division 305 excluding the short region 331. Further, the system may update the map database 105a as the second administrative division 307 is changed to the second geographic region. For instance, the second geographic region may include the second administrative division 307 and the short region 331.

In various embodiments, the system 101 may be configured to generate the navigation instructions for the vehicle 301, based on one or more of the new administrative boundary, the road object data associated with the road object 329, and the driving direction data 319. To that end, the system 101 may be configured to determine the road object data associated with the road object 329. For determining the road object data associated with the road object 329, the system 101 may identify the road object value and the road object type associated with the received road object observation. If the road object type is identified as different from the speed limit sign (e.g. the speed limit end sign), the system 101 may be configured to determine, using the driving direction data 319, whether the vehicle 301 is traveling from the first administrative division 305 (e.g. Non-BUA) to the second administrative division 307 (e.g. BUA) or the second administrative division 307 (e.g. BUA) to the first administrative division 305 (e.g. Non-BUA).

In response to determining the vehicle 301 is traveling from the first administrative division 305 to the second administrative division 307, the system 101 may generate the navigation instructions for the vehicle 301. In some example embodiments, the system 101 may determine the first attribute value for generating the navigation instructions. For instance, the first attribute value may be the speed value associated with the vehicle 301, when the road object observation was received. Further, the system 101 may determine the second attribute value as the first attribute and the third attribute value as the default speed value associated with the second administrative division 307, when the road object 329 is the valid road object and the road object type is at least one of the speed limit end sign, the end of restriction sign, or the like. Furthermore, the system 101 may generate the navigation instructions to apply the second attribute value to the first geographic region and the third attribute value to the second geographic region. In some other example embodiments, the system 101 may generate, for the vehicle 301, the navigation instructions to: propagate the vehicle 301 with the speed limit value associated with the first administrative division 305 while traveling on the first administrative division 305 and until reaching the new administrative boundary (e.g. the location associated with the road object 329); change the speed limit value associated with the vehicle 301 to the default speed limit value associated with the second administrative division 307 after reaching the new administrative boundary and until reaching the administrative boundary 309; and not to change the speed limit value associated with the vehicle 301 after reaching the administrative boundary 309. In other words, the system 101 may generate the navigation instructions to change the speed value associated with the vehicle 301 to the default speed value associated with the second administrative division 307 after reaching the new administrative boundary. For instance, the default speed value associated with the BUA may be 50 kmph.

Further, in some embodiments, the system 101 may update the map database 105a based on the generated navigation instructions. In some example embodiments, the system 101 may update the map database 105a with the second attribute value associated with the first geographic region and the third attribute value associated with the second geographic region. In some other example embodiments, the system 101 may update the map database 105a with the generated navigation instructions associated with the short region 331. For example, the navigation instructions associated with the short region 331 may be to change the speed limit value associated with the vehicle 301 to the default speed limit value associated with the second administrative division 307 after reaching the new administrative boundary and until reaching the administrative boundary 309.

In this way, the system 101 validates the road object 329 and generates the navigation instructions to the vehicle 301 such that the multiple transitions of the vehicle 301 are reduced while the vehicle 301 is traveling from one administrative division to another administrative division. Accordingly, the system 101 avoids the unwanted conditions. Here for the purpose of explanation, the vehicle 301 traveling from the first administrative division 305 to the second administrative division 307 is considered. For instance, the vehicle 301 may travel from the second administrative division 307 to the first administrative division 305. When the vehicle 301 is traveling from the second administrative division 307 to the first administrative division 305, the system 101 may validate the road object and generate the navigation instructions as explained in the detailed description of FIG. 3F.

FIG. 3F illustrates a fifth working environment 300f of the system 101 for validating a road object 333, in accordance with one or more example embodiments. The fifth working environment 300f includes a scenario that is showing the road object 333 indicative of the speed limit sign; the road object 333 located on the first administrative division 305; and the vehicle 301 is traveling from the second administrative division 307 (e.g. BUA) to the first administrative division 305 (e.g. Non-BUA). As explained in FIG. 3A, a short region 335 (also referred to as a short road segment 335) may be formed between the administrative boundary 309 and the location associated with the road object 333, due to at least one of the change in the administrative boundary 309, the GPS errors, the sight distance effects, the outdated map data and the like.

In various embodiments, the system 101 may receive the road object observation associated with the road object 333 and identify the driving direction data 319. In various embodiments, the system 101 may obtain the administrative boundary 309 that is in the vicinity of the road object 333. In various embodiments, the system 101 may be configured to validate the road object 333 based on a distance between the location data associated with the road object 333 and the administrative boundary 309. For instance, the system 101 may compare the distance between the location data associated with the road object 333 and the administrative boundary 309 with the threshold range (e.g., the range of 100 meters-300 meters).

If the distance between the location data associated with the road object 333 and the administrative boundary 309 is within the threshold range, the system 101 may identify the road object 333 as the valid road object. Once the road object 333 is identified as the valid road object, the system 101 may determine the relative position of the road object 333 with respect to the administrative boundary 309. Further, the system 101 may validate the road object 333 based on the relative position of the road object 333, and the driving direction data 319. For instance, validating the road object 333 based on the relative position of the road object 333 may be include checking whether the road object 333 is located in the first administrative division 305 or the road object 333 is located in the second administrative division 307. For instance, validating the road object 333 based on the driving direction data 319 may include checking whether the vehicle 301 is transitioning from the first administrative division 305 to the second administrative division 307 or the vehicle 301 is transitioning from the second administrative 307 to the first administrative division 305.

If the road object 333 is located ii the first administrative division 305, the system 101 may determine the location associated with the road object 333 on the first administrative division 305 as the new administrative boundary. In some example embodiments, the system 101 may update the map database 105a with the new administrative boundary. For instance, the system 101 may update the map database 105a to include that the administrative boundary 309 is changed to the new administrative boundary (e.g. the location data of the road object 333). In other words, the system 101 may update the map database 105a as the second administrative division 307 is changed to the second geographic region. For instance, the second geographic region may include the second administrative division 307 and the short region 335. Further, the system 101 may update the map database 105a as the first administrative division 305 is changed to the first geographic region. For instance, the first geographic region may be the first administrative division 305 excluding the short region 335.

In various embodiments, the system 101 may be configured to generate the navigation instructions for the vehicle 301, based on one or more of the new administrative boundary, the road object data associated with the road object 333, and the driving direction data 319. To that end, the system 101 may be configured to determine the road object data associated with the road object 333. For determining the road object data associated with the road object 333, the system 101 may identify the road object value and the road object type associated with the received road object observation. If the road object type is identified as the speed limit sign, the system 101 generates the navigation instructions for the vehicle 301, based on the new administrative boundary and the road object value. In some example embodiments, the system 101 may determine the first attribute value for generating the navigation instructions. For instance, the first attribute value may be the speed value associated with the vehicle 301, when the road object observation was received. Further, the system 101 may determine the second attribute value as the first attribute and the third attribute value as the road object value of the road object 333, when the road object 333 is the valid road object and the road object type is the speed limit sign. Furthermore, the system 101 may generate the navigation instructions to apply the second attribute value to the second geographic region and the third attribute value to the first geographic region. In some other example embodiments, the system 101 may generate, for the vehicle 301, the navigation instructions to: propagate the vehicle 301 with the speed limit value associated with the second administrative division 307 until reaching the administrative boundary 309; not to change the speed limit value associated with the vehicle 301 after reaching the administrative boundary 309 and until reaching the new administrative boundary (e.g. the location associated with the road object 333); and change the speed limit value associated with the vehicle 301 to the speed limit value associated with the road object 333 after reaching the new administrative boundary. In other words, the system 101 may generate the navigation instructions to change the speed value associated with the vehicle 301 to the speed limit value associated with the road object 333 after reaching the new administrative boundary.

Further, in some embodiments, the system 101 may update the map database 105a based on the generated navigation instructions. In some example embodiments, the system 101 may update the map database 105a with the second attribute value and the third attribute value. In some other example embodiments, the system 101 may update the map database 105a with the generated navigation instructions associated with the short region 335. For example, the navigation instructions associated with the short region 335 may be not to change the speed limit value associated with the vehicle 301 after reaching the administrative boundary 309 and until reaching the new administrative boundary (e.g. the location associated with the road object 325).

In this way, the system 101 validates the road object 333 and generates the navigation instructions to the vehicle 301 such that the multiple transitions of the vehicle 301 are reduced while the vehicle 301 is traveling from one administrative division to another administrative division. Accordingly, the system 101 avoids the unwanted conditions. Here for the purpose of explanation, the road object 333 is considered as the speed limit sign. For instance, the road object may be the speed limit end sign. When the road object is the speed limit end sign, the system 101 may validate the road object and generate the navigation instructions as explained in the detailed description of FIG. 3G.

FIG. 3G illustrates a sixth working environment 300g of the system 101 for validating a road object 337, in accordance with one or more example embodiments. The sixth working environment 300g includes a scenario that is showing the road object 337 indicative of the speed limit end sign; the road object 337 located on the first administrative division 305; and the vehicle 301 is traveling from the second administrative division 307 (e.g. BUA) to the first administrative division 305 (e.g. Non-BUA). As explained in FIG. 3A, a short region 339 (also referred to as a short road segment 339) may be formed between the administrative boundary 309 and the location associated with the road object 337, due to at least one of the change in the administrative boundary 309, the GPS errors, the sight distance effects, the outdated map data and the like.

In various embodiments, the system 101 may receive the road object observation associated with the road object 337 and identify the driving direction data 319. In various embodiments, the system 101 may obtain the administrative boundary 309 that is in the vicinity of the road object 337. In various embodiments, the system 101 may be configured to validate the road object 337 based on a distance between the location data associated with the road object 337 and the administrative boundary 309. For instance, the system 101 may compare the distance between the location data associated with the road object 337 and the administrative boundary 309 with the threshold range (e.g., the range of 100 meters-300 meters).

If the distance between the location data associated with the road object 337 and the administrative boundary 309 is within the threshold range, the system 101 may identify the road object 337 as the valid road object. Once the road object 337 is identified as the valid road object, the system 101 may determine the relative position of the road object 337 with respect to the administrative boundary 309. Further, the system 101 may validate the road object 337 based on the relative position of the road object 337, and the driving direction data 319. For instance, validating the road object 337 based on the relative position of the road object 337 may be include checking whether the road object 337 is located in the first administrative division 305 or the road object 337 is located in the second administrative division 307. For instance, validating the road object 337 based on the driving direction data 319 may include checking whether the vehicle 301 is transitioning from the first administrative division 305 to the second administrative division 307 or the vehicle 301 is transitioning from the second administrative 307 to the first administrative division 305.

If the road object 337 is located on the first administrative division 305, the system 101 may determine the location associated with the road object 337 on the first administrative division 305 as the new administrative boundary. In some example embodiments, the system 101 may update the map database 105a with the new administrative boundary. For instance, the system 101 may update the map database 105a to include that the administrative boundary 309 is changed to the new administrative boundary (e.g. the location data of the road object 337). In other words, the system 101 may update the map database 105a as the second administrative division 307 is changed to the second geographic region. For instance, the second geographic region may include the second administrative division 307 and the short region 339. Further, the system 101 may update the map database 105a is the first administrative division 305 as changed to the first geographic region. For instance, the first geographic region may be the first administrative division 305 excluding the short region 339.

In various embodiments, the system 101 may be configured to generate the navigation instructions for the vehicle 301, based on one or more of the new administrative boundary, the road object data associated with the road object 337, and the driving direction data 319. To that end, the system 101 may be configured to determine the road object data associated with the road object 337. For determining the road object data associated with the road object 337, the system 101 may identify the road object value and the road object type associated with the received road object observation. If the road object type is identified as different from the speed limit sign (e.g. the speed limit end sign), the system 101 may be configured to determine, using the driving direction data 319, whether the vehicle 301 is traveling from the first administrative division 305 (e.g. Non-BUA) to the second administrative division 307 (e.g. BUA) or from the second administrative division 307 (e.g. BUA) to the first administrative division 305 (e.g. Non-BUA).

In response to determining the vehicle 301 is traveling from the second administrative division 307 (e.g. BUA) to the first administrative division 305 (e.g. Non-BUA), the system 101 may generate the navigation instructions for the vehicle 301. In some example embodiments, the system 101 may determine the first attribute value for generating the navigation instructions. For instance, the first attribute value may be the speed value associated with the vehicle 301, when the road object observation was received. Further, the system 101 may determine the second attribute value as the first attribute and the third attribute value as the default speed value associated with the first administrative division 305, when the road object 337 is the valid road object and the road object type is at least one of the speed limit end sign, the end of restriction sign, or the like. Furthermore, the system 101 may generate the navigation instructions to apply the second attribute value to the second geographic region and the third attribute value to the first geographic region. In some other example embodiments, the system 101 may generate, for the vehicle 301, the navigation instructions to: propagate the vehicle 301 with the speed limit value associated with the second administrative division 307 while traveling on the second administrative division 307 until reaching the administrative boundary 309; not to change the speed limit value associated with the vehicle 301 after reaching the administrative boundary 309 until reaching the new administrative boundary (e.g. the location associated with the road object 337); and propagate the vehicle 301 with a default speed value (e.g. speed limit value of 100 kmph) associated with the first administrative division 305 (e.g. Non-BUA) after reaching the new administrative boundary. In other words, the system 101 may generate the navigation instructions to change the speed value associated with the vehicle 301 to the default speed value associated with the first administrative division 305 after reaching the new administrative boundary. For instance, the default speed value associated with the Non-BUA may be 100 kmph.

Further, in some embodiments, the system 101 may update the map database 105a based on the generated navigation instructions. In some example embodiments, the system 101 may update the map database 105a with the second attribute value and the third attribute value. In some other example embodiments, the system 101 may update the map database 105a with the generated navigation instructions associated with the short region 339. For example, the navigation instructions associated with the short region 339 may be not to change the speed limit value associated with the vehicle 301 after reaching the administrative boundary 309 and until reaching the new administrative boundary (e.g. the location associated with the road object 337).

In this way, the system 101 validates the road object 337 and generates the navigation instructions to the vehicle 301 such that the multiple transitions of speed of the vehicle 301 are reduced while the vehicle 301 is traveling from one administrative division to another administrative division. Accordingly, the system 101 avoids the unwanted conditions. Here for the purpose of explanation, the road object 337 located on the first administrative division 305 is considered. For instance, the road object may be located on the second administrative division 307. When the road object located on the second administrative division 307, the system 101 may validate the road object and generate the navigation instructions as explained in the detailed description of FIG. 3H.

FIG. 3H illustrates a seventh working environment 300h of the system 101 for validating a road object 341, in accordance with one or more example embodiments. The seventh working environment 300h includes a scenario that is showing the road object 341 indicative of the speed limit sign; the road object 341 located on the second administrative division 307; and the vehicle 301 is traveling from the second administrative division 307 (e.g. BUA) to the first administrative division 305 (e.g. Non-BUA). As explained in FIG. 3A, a short region 343 (also referred to as a short road segment 343) may be formed between the administrative boundary 309 and the location associated with the road object 341, due to at least one of the change in the administrative boundary 309, the GPS errors, the sight distance effects, the outdated map data and the like.

In various embodiments, the system 101 may receive the road object observation associated with the road object 341 and identify the driving direction data 319. In various embodiments, the system 101 may obtain the administrative boundary 309 that is in the vicinity of the road object 341. In various embodiments, the system 101 may be configured to validate the road object 341 based on a distance between the location data associated with the road object 341 and the administrative boundary 309. For instance, the system 101 may compare the distance between the location data associated with the road object 341 and the administrative boundary 309 with the threshold range (e.g., the range of 100 meters-300 meters).

If the distance between the location data associated with the road object 341 and the administrative boundary 309 is within the threshold range, the system 101 may identify the road object 341 as the valid road object. Once the road object 341 is identified as the valid road object, the system 101 may determine the relative position of the road object 341 with respect to the administrative boundary 309. Further, the system 101 may validate the road object 341 based on the relative position of the road object 341, and the driving direction data 319. For instance, validating the road object 341 based on the relative position of the road object 341 may be include checking whether the road object 341 is located in the first administrative division 305 or the road object 341 is located in the second administrative division 307. For instance, validating the road object 341 based on the driving direction data 319 may include checking whether the vehicle 301 is transitioning from the first administrative division 305 to the second administrative division 307 or the vehicle 301 is transitioning from the second administrative 307 to the first administrative division 305.

If the road object 341 is located in the second administrative division 307, the system 101 may determine the location associated with the road object 341 on the second administrative division 307 as the new administrative boundary. In some example embodiments, the system 101 may update the map database 105a with the new administrative boundary. For instance, the system 101 may update the map database 105a as the administrative boundary 309 is changed to the new administrative boundary (e.g. the location data of the road object 341). In other words, the system 101 may update the map database 105a as the second administrative division 307 is changed to the second geographic region. For instance, the second geographic region may be the second administrative division 307 excluding the short region 343. Further, the system 101 may update the map database 105a as the first administrative division 305 is changed to the first geographic region. For instance, the first geographic region may include the first administrative division 305 and the short region 343.

In various embodiments, the system 101 may be configured to generate the navigation instructions for the vehicle 301, based on one or more of the new administrative boundary, the road object data associated with the road object 341, and the driving direction data 319. To that end, the system 101 may be configured to determine the road object data associated with the road object 341. For determining the road object data associated with the road object 341, the system 101 may identify the road object value and the road object type associated with the received road object observation. If the road object type is identified as the speed limit sign, the system 101 generates the navigation instructions for the vehicle 301, based on the new administrative boundary and the road object value. In some example embodiments, the system 101 may determine the first attribute value for generating the navigation instructions. For instance, the first attribute value may be the speed value associated with the vehicle 301, when the road object observation was received. Further, the system 101 may determine the second attribute value as the first attribute and the third attribute value as the road object value of the road object 341, when the road object 341 is the valid road object and the road object type is the speed limit sign. Furthermore, the system 101 may generate the navigation instructions to apply the second attribute value to the second geographic region and the third attribute value to the first geographic region. In some other example embodiments, the system 101 may generate, for the vehicle 301, the navigation instructions to: propagate the vehicle 301 with the speed limit value associated with the second administrative division 307 until reaching the new administrative boundary; change the speed limit value associated with the vehicle 301 to the speed limit value associated with the road object 341 after reaching the new administrative boundary (e.g. the location associated with the road object 341) and until reaching the administrative boundary 309; and not to change the speed limit value associated with the vehicle 301 after reaching the administrative boundary 309. In other words, the system 101 may generate the navigation instructions to change the speed value associated with the vehicle 301 to the speed limit value associated with the road object 341 after reaching the new administrative boundary.

Further, in some embodiments, the system 101 may update the map database 105a based on the generated navigation instructions. In some example embodiments, the system 101 may update the map database 105a with the second attribute value and the third attribute value. In some other example embodiments, the system 101 may update the map database 105a with the generated navigation instructions associated with the short region 343. For example, the navigation instructions associated with the short region 343 may be to change the speed limit value associated with the vehicle 301 to the speed limit value associated with the road object 341 after reaching the new administrative boundary (e.g. the location associated with the road object 341) and until reaching the administrative boundary 309.

In this way, the system 101 validates the road object 341 and generates the navigation instructions to the vehicle 301 such that the multiple transitions of the vehicle 301 are reduced while the vehicle 301 is traveling from one administrative division to another administrative division. Accordingly, the system 101 avoids the unwanted conditions. Here for the purpose of explanation, the road object 341 is considered as the speed limit sign. For instance, the road object may be the speed limit end sign. When the road object is the speed limit end sign, the system 101 may validate the road object and generate the navigation instructions as explained in the detailed description of FIG. 3I.

FIG. 3I illustrates an eighth working environment 300i of the system 101 for validating a road object 345, in accordance with one or more example embodiments. The eight working environment 300i includes a scenario that is showing the road object 345 indicative of the speed limit end sign; the road object 345 located on the second administrative division 307; and the vehicle 301 is traveling from the second administrative division 307 (e.g. BUA) to the first administrative division 305 (e.g. Non-BUA). As explained in FIG. 3A, a short region 347 (also referred to as a short road segment 347) may be formed between the administrative boundary 309 and the location associated with the road object 345, due to at least one of the change in the administrative boundary 309, the GPS errors, the sight distance effects, the outdated map data and the like.

In various embodiments, the system 101 may receive the road object observation associated with the road object 345 and identify the driving direction data 319. In various embodiments, the system 101 may obtain the administrative boundary 309 that is in the vicinity of the road object 345. In various embodiments, the system 101 may be configured to validate the road object 345 based on a distance between the location data associated with the road object 345 and the administrative boundary 309. For instance, the system 101 may compare the distance between the location data associated with the road object 345 and the administrative boundary 309 with the threshold range (e.g., the range of 100 meters-300 meters).

If the distance between the location data associated with the road object 345 and the administrative boundary 309 is within the threshold range, the system 101 may identify the road object 345 as the validated road object. Once the road object 345 is identified as the validated road object, the system 101 may determine the relative position of the road object 345 with respect to the administrative boundary 309. Further, the system 101 may validate the road object 345 based on the relative position of the road object 345, and the driving direction data 319. For instance, validating the road object 345 based on the relative position of the road object 345 may be include checking whether the road object 345 is located in the first administrative division 305 or the road object 345 is located in the second administrative division 307. For instance, validating the road object 345 based on the driving direction data 319 may include checking whether the vehicle 301 is transitioning from the first administrative division 305 to the second administrative division 307 or the vehicle 301 is transitioning from the second administrative 307 to the first administrative division 305.

If the road object 345 is located on the second administrative division 307, the system 101 may determine the location associated with the road object 345 on the second administrative division 307 as the new administrative boundary. In some example embodiments, the system 101 may update the map database 105a with the new administrative boundary. For instance, the system 101 may update the map database 105a as the administrative boundary 309 is changed to the new administrative boundary (e.g. the location data of the road object 345). In other words, the system 101 may update the map database 105a as the second administrative division 307 is changed to the second geographic region. For instance, the second geographic region may be the second administrative division 307 excluding the short region 347. Further, the system 101 may update the map database 105a as the first administrative division 305 is changed to the first geographic region. For instance, the first geographic region may include the first administrative division 305 and the short region 347.

In various embodiments, the system 101 may be configured to generate the navigation instructions for the vehicle 301, based on one or more of the new administrative boundary, the road object data associated with the road object 345, and the driving direction data 319. To that end, the system 101 may be configured to determine the road object data associated with the road object 345. For determining the road object data associated with the road object 345, the system 101 may identify the road object value and the road object type associated with the received road object observation. If the road object type is identified as different from the speed limit sign (e.g. the speed limit end sign), the system 101 may be configured to determine, using the driving direction data 319, whether the vehicle 301 is traveling from the first administrative division 305 (e.g. Non-BUA) to the second administrative division 307 (e.g. BUA) or the second administrative division 307 (e.g. BUA) to the first administrative division 305 (e.g. Non-BUA).

In response to determining the vehicle 301 is traveling from the second administrative division 307 to the first administrative division 305, the system 101 may generate the navigation instructions for the vehicle 301. In some example embodiments, the system 101 may determine the first attribute value for generating the navigation instructions. For instance, the first attribute value may be the speed value associated with the vehicle 301, when the road object observation was received. Further, the system 101 may determine the second attribute value as the first attribute and the third attribute value as the default speed value associated with the first administrative division 305, when the road object 345 is the valid road object and the road object type is at least one of the speed limit end sign, the end of restriction sign, or the like. Furthermore, the system 101 may generate the navigation instructions to apply the second attribute value to the second geographic region and the third attribute value to the first geographic region. In some other example embodiments, the system 101 may generate, for the vehicle 301, the navigation instructions to: propagate the vehicle 301 with the speed limit value associated with the second administrative division 307 while traveling on the second administrative division 307 and until reaching the new administrative boundary (e.g. the location associated with the road object 345); change the speed limit value associated with the vehicle 301 to the default speed limit value associated with the first administrative division 305 after reaching the new administrative boundary and until reaching the administrative boundary 309; and not to change the speed limit value associated with the vehicle 301 after reaching the administrative boundary 309. In other words, the system 101 may generate the navigation instructions to change the speed value associated with the vehicle 301 to the default speed value associated with the first administrative division 305 after reaching the new administrative boundary. For instance, the default speed value associated with the Non-BUA may be 100 kmph.

Further, in some embodiments, the system 101 may update the map database 105a based on the generated navigation instructions. In some example embodiments, the system 101 may update the map database 105a with the second attribute value and the third attribute value. In some other example embodiments, the system 101 may update the map database 105a with the generated navigation instructions associated with the short region 347. For example, the navigation instructions associated with the short region 347 may be to change the speed limit value associated with the vehicle 301 to the default speed limit value associated with the first administrative division 305 after reaching the new administrative boundary and until reaching the administrative boundary 309.

In this way, the system 101 validates the road object 345 and generates the navigation instructions to the vehicle 301 such that the multiple transitions of speed of the vehicle 301 are reduced while the vehicle 301 is traveling from one administrative division to another administrative division. Accordingly, the system 101 avoids the unwanted conditions. Further, the system 101 may use the updated map database 105a and/or the generated navigation instructions to provide one or more navigation functions such as providing vehicle speed guidance, vehicle speed handling and/or control, providing a route for navigation (e.g., via a user interface), localization, route determination, lane level speed determination, operating the vehicle along a lane level route, route travel time determination, lane maintenance, route guidance, provision of traffic information/data, provision of lane level traffic information/data, vehicle trajectory determination and/or guidance, route and/or maneuver visualization, and/or the like.

In some embodiments, the system 101 validates the road object 303 according to any one of the scenarios depicted in FIGS. 3B-3I based on at least two criteria including: the distance between the road object 303 and the administrative boundary 309, the driving direction 319 and the relative position of the road object 303 with respect to the administrative boundary 309. The validation of the road object 303 in this manner is further explained in conjunction with the following method flowcharts.

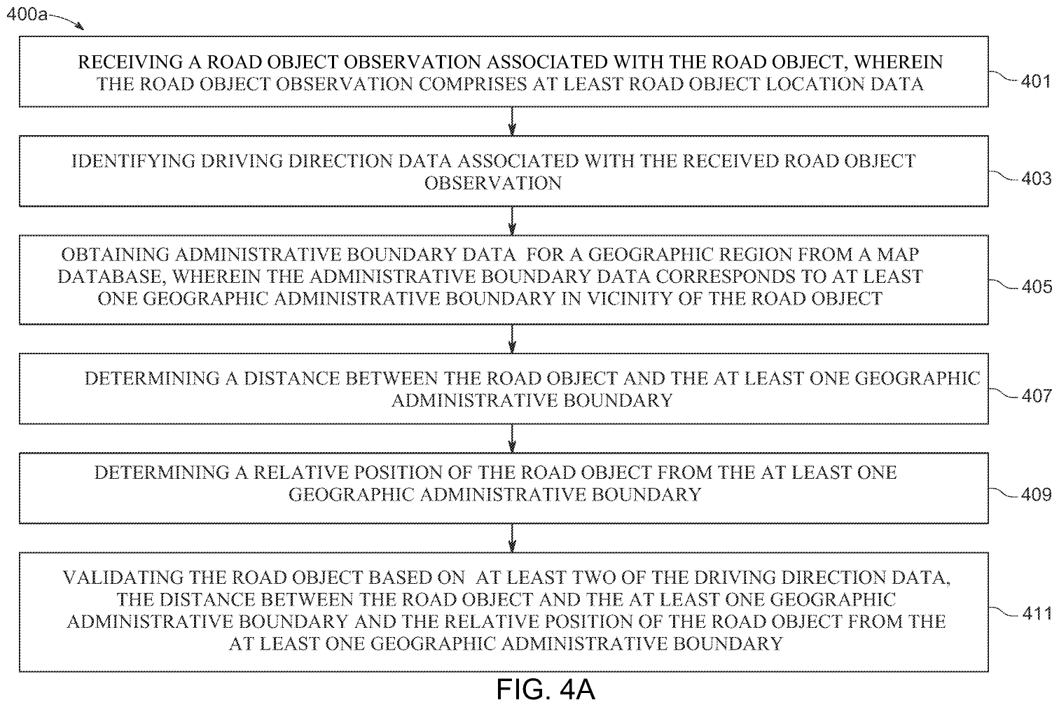

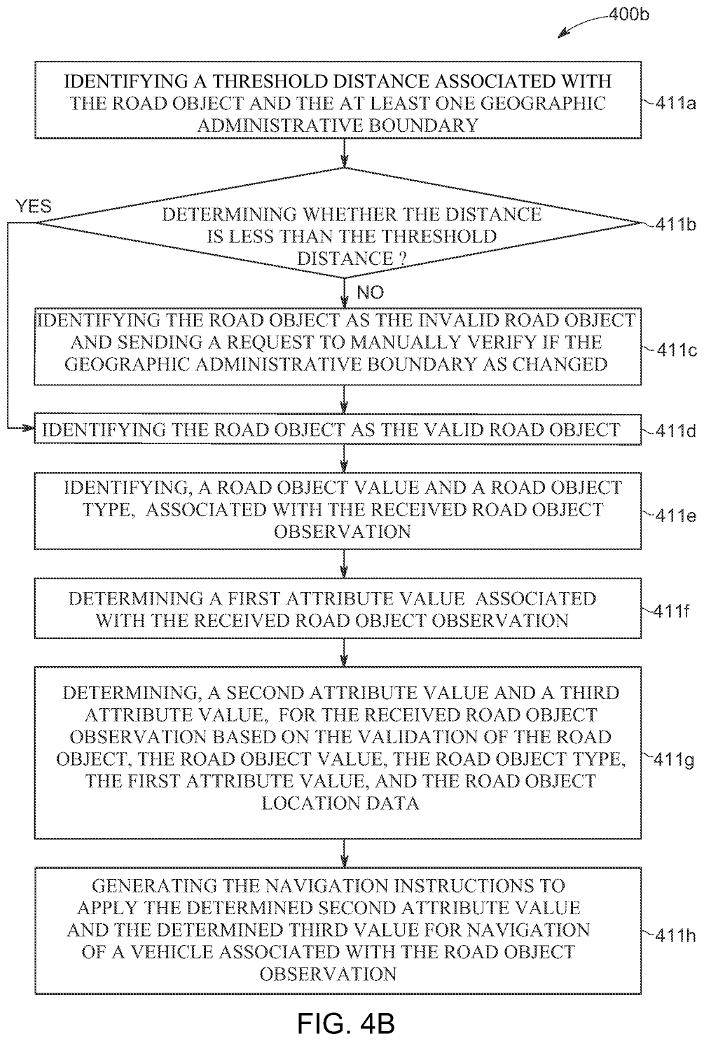

FIG. 4A illustrates a flowchart depicting a method 400a for validating the road object, in accordance with one or more example embodiments. It will be understood that each block of the flow diagram of the method 400a may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by the memory 203 of the system 101, employing an embodiment of the present invention and executed by the processor 201. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram 400a support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions.

Starting at block 401, the method 400a may include receiving the road object observation associated with the road object 303. For instance, the sensor data reception module 201a may receive the road object observation associated with the road object 303. The road object observation may include the road object location data and the road object data. Additionally, the road object observation may include the timestamp.

At block 403, the method 400a may include identifying the driving direction data 319 associated with the road object observation. For instance, the sensor data reception module 201a may identify the driving direction data 319 associated with the road object observation.

At block 405, the method 400a may include obtaining the administrative boundary data for the geographic region from the map database 105a. In various embodiments, the administrative boundary data may corresponds to at least one administrative boundary 309 that is in the vicinity of the road object 309. For instance, the administrative boundary data module 201b may obtain the administrative boundary data for the geographic region from the map database 105a.

At block 407, the method 400a may include determining the distance between the road object 303 and the at least one administrative boundary 309. For instance, the distance determination module 201c may determine the distance between the road object 303 and the at least one administrative boundary 309.

At step 409, the method 400a may include determining the relative position of the road object 303 from the at least one administrative boundary 309. For instance, the relative position determination module 201d may determine the relative position of the road object 303 from the at least one administrative boundary 309. In various embodiments, the relative position may be determined as at least one of the upstream position with respect to the administrative boundary 309 and the downstream position with respect to the administrative boundary 309.

At step 411, the method 400a may include validating the road object 303 based on at least two of the driving direction data 319, the distance between the road object 303 and the at least one administrative boundary 309 and the relative position of the road object 303 from the at least one administrative boundary 309. For instance, the road object validation module 201e may validate the road object 303 based on at least two of the driving direction data 319, the distance between the road object 303 and the at least one administrative boundary 309 and the relative position of the road object 303 from the at least one administrative boundary 309. Further, the validation of the road object 303 is as explained in the detailed description of FIG. 4B.

FIG. 4B illustrates a flowchart depicting a method 400b for validating the road object 303, based on at least two of the driving direction data 319, the distance between the road object 303 and the at least one administrative boundary 309 and the relative position of the road object 303 from the at least one administrative boundary 309, in accordance with one or more example embodiments. The method 400b may be used in conjunction with the system 101 described in the detail description of FIGS. 3A-3I. Although various steps of method 400b are described below and depicted in FIG. 4B, the steps need not necessarily all be performed, and in some cases may be performed in a different order than the order shown.

Starting at block 411a, the method 400b may include identifying the threshold distance associated with the road object 303 and the at least one administrative boundary 309. For instance, the road object validation module 201e may identifying the threshold distance associated with the road object 303 and the at least one administrative boundary 309.

At block 411b, the method 400b may include determining whether the distance between the road object 303 and the at least one administrative boundary 309 is less than the threshold distance. For instance, the road object validation module 201e may determine whether the distance between the road object 303 and the at least one administrative boundary 309 is less than the threshold distance (such as 100 m-300 m as discussed earlier). In some other example embodiments, the road object validation module 201e may determine whether the distance between the road object 303 and the at least one administrative boundary 309 is within the threshold range. In various embodiments, the threshold range or the threshold distance may be determined by experimentation and the like.

If the distance between the road object 303 and the at least one administrative boundary 309 is not less than the threshold distance, the method 400b may proceed with block 411c. At block 411c, the method 400b may include identifying the road object 303 as the invalid road object. Further, at block 411c, the method 400b may include sending the request to manually verify if the administrative boundary 309 as changed.

If the distance between the road object 303 and the at least one administrative boundary 309 is less than the threshold distance, the method 400b may proceed with block 411d. At block 411d, the method 400b may include identifying the road object 303 as the valid road sign. For instance, the road object validation module 201e may identify the road object 303 as the valid road object. Further, at step 411d, the method 400b may include determining whether the road object 303 is located on at least one of the first administrative division 305 and the second administrative division 307, based on the relative position of the road object 303.

At block 411e, the method 400b may include identifying, the road object value and the road object type, associated with the received road object observation. For instance, the navigation instructions generation module 201f may identify, the road object value and the road object type, associated with the received road object observation.

At block 411f, the method 400b may include determining the first attribute value associated with the received road object observation. For instance, the navigation instructions generation module 201f may determine the first attribute value associated with the received road object observation. In some example embodiments, the first attribute value may be the speed value associated with the vehicle 301, when the road object observation was received.

At block 411g, the method 400b may include determining, the second attribute value and the third attribute value, for the received road object observation based on the valid road object, the road object value, the road object type, the first attribute value, and the road object location data. For instance, the navigation instructions generation module 201f may determine, the second attribute value and the third attribute value, for the received road object observation based on the valid road object, the road object value, the road object type, the first attribute value, and the road object location data. The second attribute value may be associated with the first geographic region that is traversed before reaching the road object location. The third attribute value may be associated with the second geographic region that is traversed after passing the road object location. In various embodiments, the road object location may be determined based on the road object location data and may be associated with the geographic region obtained from the map database 105a.

At block 411h, the method 400b may include generating the navigation instructions to apply the determined second attribute value and the determined third value for navigating the vehicle 301. For instance, the navigation instructions generation module 201f may generate the navigation instructions to apply the determined second attribute value and the determined third value for navigating the vehicle 301. Further, at block 411h, the method 400b may include updating the map database 105a, based on at least one of the road object location data, the relative position of the road object 303, the road object data associated with the road object 303, and/or the generated navigation instructions as discussed in FIGS. 3A-3I.

On implementing the methods 400a-400b disclosed herein, the system 101 may be configured to validate the road object 303 that is located near the administrative boundary 309 and update the map database 105a based on the location of the road sign 303. Further, the system 101 may be configured to generate the navigation instructions for the vehicle 301 such that the multiple transitions of the vehicle 301 is reduced or avoided, while the vehicle 301 is traveling from one administrative division to another administrative division. Accordingly, the system 101 avoids the unwanted conditions such as road accidents, increase in travel time, vehicle efficiency reduction, traffic congestions, environmental pollutions, and the like. Furthermore, the system 101 may use the generate navigation instructions and/or the updated map database 105a to provide one or more navigation functions such as vehicle speed guidance, vehicle speed handling and/or control, providing a route for navigation (e.g., via a user interface), localization, route determination, lane level speed determination, and the like.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

We claim:

1. A computer-implemented method for validating a road object, comprising:
receiving a road object observation associated with the road object, wherein the road object observation comprises at least road object location data;
identifying driving direction data associated with the received road object observation;
obtaining administrative boundary data for a geographic region from a map database, wherein the administrative boundary data corresponds to at least one geographic administrative boundary in vicinity of the road object;
determining a distance between the road object and the at least one geographic administrative boundary;
determining a relative position of the road object from the at least one geographic administrative boundary; and
validating the road object based on at least two of the driving direction data, the distance between the road object and the at least one geographic administrative boundary, and the relative position of the road object from the at least one geographic administrative boundary.

2. The computer-implemented method of claim 1, wherein validating the road object further comprises:
identifying a threshold distance associated with the road object and the at least one geographic administrative boundary;
comparing the distance between the road object and the at least one geographic administrative boundary with the threshold distance; and
validating the road object based on the comparison.

3. The computer-implemented method of claim 1, wherein the road object is identified as either one of a valid road object and an invalid road object based on the validation.

4. The computer-implemented method of claim 3, wherein the road object is identified as the valid road object when the distance between the road object and the at least one geographic administrative boundary is less than the threshold distance; and the road object is identified as the invalid road object when the distance between the road object and the at least one geographic administrative boundary is more than the threshold distance.

5. The computer-implemented method of claim 3, further comprising:
identifying, a road object value and a road object type, associated with the received road object observation;
determining a first attribute value associated with the received road object observation;
determining, a second attribute value and a third attribute value, for the received road object observation based on the valid road object, the road object value, the road object type, the first attribute value, and the road object location data,
wherein the second attribute value is associated with a first geographic region that is traversed before reaching the road object location and the third attribute value is associated with a second geographic region that is traversed after passing the road object location,
wherein the road object location is determined based on the road object location data and is associated with a map of the geographic region obtained from the map database.

6. The computer-implemented method of claim 5, wherein the second attribute value is same as the first attribute value and the third attribute value is same as the road object value when: the road object is the valid road object, and the road object type is a speed limit sign.

7. The computer-implemented method of claim 5, wherein the second attribute value is same as the first attribute value and the third attribute value is a predefined default value when: the road object is the valid road object, and the road object type is an end of restriction sign.

8. The computer-implemented method of claim 1, wherein determining the relative position of the road object further comprises determining the relative position as at least one of: an upstream position with respect to the at least one geographic administrative boundary; and a downstream position with respect to the at least one geographic administrative boundary.

9. The computer-implemented method of claim 1, wherein the at least one geographic administrative boundary is associated with at least one of: a built-up-area, a non-built-up-area, a city limit start, a city limit end, an in-town region, an out-of-town region, and a census designated place (CDP).

10. The computer-implemented method of claim 1, wherein the driving direction data associated with the received road object observation comprises an indication of transitioning from a first administrative division to a second administrative division based on the obtained administrative boundary data for the geographic region.

11. The computer-implemented method of claim 1, further comprising:
determining a change in the at least one geographic administrative boundary based on the validation of the road object; and
updating, based on the determined change, the map database to include updated administrative boundary data for the geographic region.

12. A system for validating a road object, the system comprising:
a memory configured to store computer-executable instructions; and
at least one processor configured to execute the computer-executable instructions to:
receive a road object observation associated with the road object, wherein the road object observation comprises at least road object location data;
obtain administrative boundary data for a geographic region from a map database, wherein the administrative boundary data corresponds to at least one geographic administrative boundary in vicinity of the road object;
determine a relative position of the road object from the at least one geographic administrative boundary; and
validate the road object based on the relative position of the road object from the at least one geographic administrative boundary, wherein the road object is identified as either one of a valid road object and an invalid road object based on the validation.

13. The system of claim 12, wherein the at least one processor is further configured to generate navigation instructions based on the validation and wherein to generate the navigation instructions, the at least one processor is further configured to:
identify, a road object value and a road object type, associated with the received road object observation;
determine a first attribute value associated with the received road object observation;
determine, a second attribute value and a third attribute value, for the received road object observation based on the validation of the road object, the road object value, the road object type, the first attribute value, and the road object location data,
wherein the second attribute value is associated with a first geographic region that is traversed before reaching the road object location and the third attribute value is associated with a second geographic region that is traversed after passing the road object location,
wherein the road object location is determined based on the road object location data and is associated with a map of the geographic region obtained from the map database; and
generate the navigation instruction to apply the determined second attribute value and the determined third value for navigation of a vehicle associated with the road object observation.

14. The system of claim 13, wherein the second attribute value is same as the first attribute value and the third attribute value is same as the road object value when: the road object is the valid road object, and the road object type is a speed limit sign.

15. The system of claim 13, wherein the second attribute value is same as the first attribute value and the third attribute value is a predefined default value when: the road object is the valid road object, and the road object type is an end of restriction sign.

16. The system of claim 12, wherein to determine the relative position of the road object, the at least one processor is further configured to: determine the relative position as at least one of: an upstream position with respect to the at least one geographic administrative boundary; and a downstream position with respect to the at least one geographic administrative boundary.

17. The system of claim 13, wherein the at least one processor is further configured to update the map database based on at least one of the road object location data, the relative position of the road object from the at least one geographic administrative boundary, the road object value, and the road object type.

18. A computer program product comprising a non-transitory computer readable medium having stored thereon computer executable instruction which when executed by at least one processor, cause the processor to carry out operations for providing one or more navigation functions, the operations comprising:
receiving location data associated with a road object and a driving direction data;
determining an administrative boundary associated with the road object based on a map database;
validating the road object based on a distance between the location data associated with the road object and the administrative boundary associated with the road object;
determining a change in the administrative boundary, based on the validated road sign and the driving direction data; and
providing the one or more navigation functions, based on the determined change in the administrative boundary and the driving direction data, wherein for providing the one or more navigation functions, the operations further comprise at least one of generating navigation instructions and updating the map database.

19. The computer program product of claim 18, wherein for determining the change in the administrative boundary, the operations further comprise:
determining a relative position of the validated road sign with respect to the administrative boundary based on the location data associated with the validated road sign and the driving direction data;
identifying whether the validated road sign is located in at least one of a first administrative division and a second administrative division, based on the relative position of the validated road sign, wherein the first administrative division and the second administrative division are separated by the administrative boundary;
determining the location data associated with the validated road sign in the first administrative division as a new administrative boundary to indicate the change in the administrative boundary, in response to identifying the validated road sign is located in the first administrative division; and
determining the location data associated with the validated road sign in the second administrative division as the new administrative boundary to indicate the change in the administrative boundary, in response to identifying the validated road sign is located in the second administrative division.

20. The computer program product of claim 19, wherein the navigation instructions are generated for a vehicle, and wherein for generating the navigation instructions for the vehicle, the operations further comprise:
determining a road object value data associated with the validated road sign;
determining, based on the driving direction data, whether the vehicle is traveling from the first administrative division to the second administrative division or from the second administrative division to the first administrative division, wherein each of the first administrative division and the second administrative division is at least one of a non-built-up area, an out-of-city area, an out-of-town area, a built-up area, an in-city area, and an in-town area;
generating the navigation instructions to change a speed value associated with the vehicle to the road object value associated with the validated road sign after reaching the new administrative boundary, if the validated road sign is the speed limit sign;
generating the navigation instructions to change the speed value associated with the vehicle to a default speed limit data associated the second administrative division after reaching the new administrative boundary, in response to determining the vehicle is traveling from the first administrative division to the second administrative division and if the validated road sign is a speed limit end sign; and
generating the navigation instructions to change the speed value associated with the vehicle to a default speed limit data associated the first administrative division after reaching the new administrative boundary, in response to determining the vehicle is traveling from the second administrative division to the first administrative division and if the validated road sign is the speed limit end sign.
